(19) United States
(12) Patent Application Publication
(10) Pub. No.: US 2024/0220835 A1
(43) Pub. Date: Jul. 4, 2024

(54) QUANTUM SENSOR NETWORK AND MEASURING A SINGLE LINEAR FUNCTION OF UNKNOWN PARAMETERS WITH A QUANTUM SENSOR NETWORK WHILE USING THE MINIMUM AMOUNT OF ENTANGLEMENT

(71) Applicant: Government of the United States of America, as represented by the Secretary of Commerce, Gaithersburg, MD (US)

(72) Inventors: Alexey Vyacheslavovich Gorshkov, Potomac, MD (US); Adam Ethan Ehrenberg, University Park, MD (US); Jacob Allen Bringewatt, Hyattsville, MD (US)

(21) Appl. No.: 18/232,890

(22) Filed: Aug. 11, 2023

Related U.S. Application Data
(63) Continuation-in-part of application No. 18/136,257, filed on Apr. 18, 2023.
(60) Provisional application No. 63/363,171, filed on Apr. 18, 2022.
(60) Provisional application No. 63/377,290, filed on Sep. 27, 2022.
(60) Provisional application No. 63/397,546, filed on Aug. 12, 2022.

(51) Int. Cl. G06N 10/20; G06N 10/70

(52) U.S. Cl. CPC G06N 10/20; G06N 10/70

(57) ABSTRACT

Measuring a single linear function q(θ1, θ2, . . . , θd) of unknown parameters {θ1, θ2, . . . , θd} with a quantum sensor network while using the minimum amount of entanglement includes: providing a plurality of d quantum sensors, wherein each quantum sensor j is configured for measuring θj; preparing the plurality of quantum sensors in a probe quantum state with a minimum amount of entanglement, such that the amount of entanglement is the smallest amount of entanglement that gives the same optimal measurement of the linear function q(θ1, θ2, . . . , θd) as if the amount of entanglement was not restricted; exposing the plurality of quantum sensors to the set of unknown parameters; measuring the plurality of quantum sensors; and calculating the single linear function q(θ1, θ2, . . . , θd) from the measurements of the plurality of quantum sensors with robust phase estimation.

### CROSS REFERENCE TO RELATED APPLICATIONS

This application is a continuation-in-part and claims benefit of U.S. patent application Ser. No. 18/136,257 (filed Apr. 18, 2023), which claims priority to U.S. Provisional Patent Application Serial No. 63/363, 171 (filed Apr. 18, 2022), the disclosures of which are incorporated herein by reference in their entirety. The application claims priority to U.S. Provisional Patent Application Ser. No. 63/377,290 (filed Sep. 27, 2022) and U.S. Provisional Patent Application Ser. No.63/397,546 (filed Aug. 12, 2022), the disclosures of which are incorporated herein by reference in their entirety.

### STATEMENT REGARDING FEDERALLY SPONSORED RESEARCH

This invention was made with United States Government support from the National Institute of Standards and Technology (NIST), an agency of the United States Department of Commerce and under Agreement No. W911NF1520067 awarded by the Army Research Lab, Agreement No. W911NF1410599 awarded by the Army Research Office, and Agreement No. W911NF16-1-0082 awarded by the Intelligence Advanced Research Projects Activity (IARPA). The Government has certain rights in the invention.

### BRIEF DESCRIPTION

Disclosed is a process for measuring a single linear function q(θ1, θ2, . .. , θd) of unknown parameters {θ1, θ2, . . . , θd} with a quantum sensor network while using the minimum amount of entanglement, the process comprising: providing a plurality of d quantum sensors, wherein each quantum sensor j is configured for measuring θj; preparing the plurality of quantum sensors in a probe quantum state |Ψ> with a minimum amount of entanglement, such that the amount of entanglement is the smallest amount of entanglement that gives the same optimal measurement of the linear function q(θ1, θ2, . . . , θd) as if the amount of entanglement was not restricted; exposing the plurality of quantum sensors to the set of unknown parameters; measuring the plurality of quantum sensors; and calculating the single linear function q(θ1, θ2, . . . , θd) from the measurements of the plurality of quantum sensors with robust phase estimation.

Disclosed is a quantum sensor network comprising: a plurality of d quantum sensors, each quantum sensor j is configured for measuring θj out of a set of unknown parameters {θ1, θ2, . . . , θd}, such that the plurality of quantum sensors is configured to be in a probe quantum state |Ψ> with a minimum amount of entanglement, such that the amount of entanglement is the smallest amount of entanglement that gives the same optimal measurement of the linear function q(θ1, θ2, . . . , θd) as if the amount of entanglement was not restricted; a network topology that connects the plurality of quantum sensors; and a controller that is configured to: prepare the plurality of quantum sensors in the probe quantum state |Ψ>; expose the plurality of quantum sensors to the unknown parameters {θ1, θ2, . . . , θd}; measure the plurality of quantum sensors; and use the measurements of the plurality of quantum sensors to calculate the function q(θ1, θ2, . . . , θd) of the set of unknown parameters.

Disclosed is a process for making a quantum sensor network that measures a single linear function q(θ1, θ2, . . . , θd), the process comprising: providing a plurality of d quantum sensors; arranging the plurality of quantum sensors in a network topology, such that each quantum sensor j is configured for measuring θj out of a set of unknown parameters {θ1, θ2, . . . , θd}; connecting the plurality of quantum sensors to a controller; preparing, by the controller, the plurality of quantum sensors in a probe quantum state |Ψ> with a minimum amount of entanglement, such that the amount of entanglement is the smallest amount of entanglement that gives the same optimal measurement of the linear function q(θ1, θ2, . . . , θd) as if the amount of entanglement was not restricted.

### BRIEF DESCRIPTION OF THE DRAWINGS

The following description cannot be considered limiting in any way. Various objectives, features, and advantages of the disclosed subject matter can be more fully appreciated with reference to the following detailed description of the disclosed subject matter when considered in connection with the following drawings, in which like reference numerals identify like elements.

FIG. 1 shows, according to some embodiments, a process for measuring a single linear function q(θ1, θ2, . . . , θd) of unknown parameters {θ1, θ2, . . . , θd} with a quantum sensor network while using the minimum amount of entanglement.

FIG. 2 shows, according to some embodiments, a process for measuring a single linear function q(θ1, θ2, . . . , θd) of unknown parameters {θ1, θ2, . . . , θd} with a quantum sensor network while using the minimum amount of entanglement.

FIG. 3 shows, according to some embodiments, a process for measuring a single linear function q(θ1, θ2, . . . , θd) of unknown parameters {θ1, θ2, . . . , θd} with a quantum sensor network while using the minimum amount of entanglement.

FIG. 4 shows, according to some embodiments, a quantum sensor network 200 that includes a plurality of quantum sensors for measuring a single linear function q(θ1, θ2, . . . , θd) of unknown parameters {θ1, θ2, . . . , θd} with a quantum sensor network while using the minimum amount of entanglement, wherein the quantum sensors are distributed among a magnetosphere of a planet.

FIG. 5 shows, according to some embodiments, a graph of CNOT cost versus number of quantum sensors d for minimum entanglement protocols using d optimally ordered states chosen either randomly or via a greedy algorithm, wherein 20 randomly chosen instances provided a valid protocol via a greedy algorithm. When it returns a valid protocol, the greedy algorithm recovers optimal linear scaling with d for the CNOT cost, whereas randomly chosen states have quadratic scaling, even with optimal state ordering.

### DETAILED DESCRIPTION

A detailed description of one or more embodiments is presented herein by way of exemplification and not limitation.

It has been discovered that processes herein include quantum entanglement in a network of quantum sensors to optimally measure a smooth function of fields at the quantum sensors while using the minimum amount of entanglement. It is contemplated that in applications for geodesy, geophysics, biology, medicine, and the like, wherein sensors can be separated by a selected distance to measure temperature, a field (e.g., magnetic field, electric field, or a combination thereof), pressure, and the like, the processes apply when the fields at the sensors are different such as a sensor that measures electric field and another sensor that measures temperature. The processes can include an array of quantum sensors such as qubit sensors, interferometers, or field-quadrature displacement sensors, measuring functions of parameters some of which are measured by qubits, while others are measured by interferometers, while others are measured by field-quadrature displacement sensors, and the like.

For a Heisenberg scaler described in U.S. Pat. No. 11,562,049, the disclosure of which is incorporated herein by reference in its entirety, fields at individual sensors or phases of individual interferometers or field-quadrature displacements are first measured without entanglement between sensors, interferometers, or field-quadrature displacement sensors to a precision sufficient for linearization of the desired smooth (analytic) function that one wants to measure. Thereafter, as herein described, the resulting linearized function is measured by distributing selected entangled states across a network of qubit sensors, interferometers, field-quadrature displacement sensors and applying quantum gates on the sensors.

Quantum sensor networks have the potential to revolutionize the way we measure the world around us. By using the power of quantum mechanics, quantum sensor networks can achieve unprecedented levels of precision and sensitivity. It has been discovered that a quantum sensor network and a protocol for measuring a function with a quantum sensor network while using the minimum amount of entanglement provide optimal measurement of a smooth function while using the minimal amount of entanglement. This is a significant improvement over conventional technology that either measures only one parameter at a time or, as in U.S. Pat. No. 11,562,049, makes use of maximally entangled states without attempting to minimize the amount of entanglement used. The quantum sensor network and the protocol for measuring a function can be used for a range of applications such as medical imaging, environmental monitoring, and national security.

In an embodiment, a quantum sensor network is arranged such that a quantum sensor at a given position senses a field that depends on a known position and a set of unknown parameters. These unknown parameters can be, e.g., positions of charges producing an electric field. According to an embodiment, an entanglement-based protocol measures an analytic function of the unknown parameters while using the minimum amount of entanglement. The analytic function can be, e.g., a value of the field at a point without a sensor or the integral of the field over some region. The entanglement-based protocol can measure properties of spatially varying fields such as magnetic fields, electric fields, gravitational fields, and temperature and can be used in applications in chemistry, medicine, biology, materials science, physics, geodesy, geophysics, and the like. Advantageously, the entanglement-based protocol performs better than conventional protocols by providing smaller uncertainty given a fixed time or providing a desired uncertainty in a shorter time. The protocols described in U.S. patent application Ser. No. 17/978,420, the disclosure of which is incorporated by reference herein in their entirety, can be used to reduce the measurement problem described in this paragraph to a simpler problem where the unknown parameters are coupled directly to the sensors. We will therefore focus on this simpler problem below.

Various types of optimally measuring field properties using sensor networks are described in U.S. patent application Ser. Nos. 17/978,420, 16/677,922, and 15/650,216, the disclosures of which are incorporated by reference herein in their entirety. Entanglement-enhanced measurement of multiple functions with a quantum sensor network is described in U.S. patent application Ser. No. 18/136,257, which is incorporated by reference herein in its entirety. The protocol described herein for measuring a single linear function q(θ1, θ2, . . . , θd) of unknown parameters {θ1, θ2, . . . , θd} with a quantum sensor network while using the minimum amount of entanglement provides the same results as in these patent applications but using the minimum amount of entanglement.

Measuring a linear function of d unknown real field parameters θᵢ coupled to d sensors involves the Hamiltonian here:

$$\hat{H} ( s ) = {\sum }_{i = 1}^{d} \frac{1}{2} {θ}_{i} {\hat{σ}}_{i}^{z} + {\hat{H}}_{c} ( s ) . \qquad ( 1 )$$

One wants to measure the function q(θ)=αθ, where θ is the d-dimensional vector containing the d field parameters θᵢ, and α is the d-dimensional vector containing real coefficients specifying the linear function we are interested in. U.S. patent application Ser. No. 15/650,216 describes how to optimally measure q starting from the maximally entangled state of the d sensors. With respect to amount of entanglement, herein are described embodiments for measuring a function with a quantum sensor network while using the minimum amount of entanglement. Such embodiments provide the same optimal measurement result and use the minimum amount of entanglement.

In an embodiment, measuring a single linear function qθ1, θ2, . . . , θd) of unknown parameters {θ1, θ2, . . . , θd} with a quantum sensor network while using the minimum amount of entanglement, also referred to herein as the protocol, embeds single linear function q(θ1, θ2, . . . , θd) into the relative phase of probe quantum state |Ψ> as

$$\vert ψ 〉 \to \frac{1}{\sqrt{2}} ( \vert 0 〉 + {e}^{iqt / {‖ α ‖}_{∞}} \vert 1 〉 ) \vert 0 …0 〉 .$$

After embedding single linear function q(θ1, θ2, . . . , θd) into the relative phase of probe quantum state |Ψ>, single linear function q(θ1, θ2, . . . , θd) can be measured using robust phase estimation.

For embedding single linear function q(θ1, θ2, . . . , θd) into the relative phase of probe quantum state |Ψ>, define fundamental probe state |ψ(τ; φ) [symbol] as

$$\vert ψ ( τ ; φ ) 〉 = \frac{1}{\sqrt{2}} ( \vert τ 〉 + {e}^{i φ} \vert - τ 〉 ) , \qquad ( 9 )$$

$$\vert τ 〉 = {{⊗}^{d}}_{j = 1} \{ \begin{matrix}\vert 0 〉 , & {τ}_{j} \neq - 1 \\ \vert 1 〉 , & {τ}_{j} = - 1\end{matrix} . \qquad ( 10 )$$

φ∈ [symbol] parameterizes individual states in the family, and τ₁=1. One embeds τ into a d×N (N=3^{d-1}) matrix T with matrix elements Tₘₙ= [symbol] ₘ⁽ⁿ⁾ for some ordering of the τ.

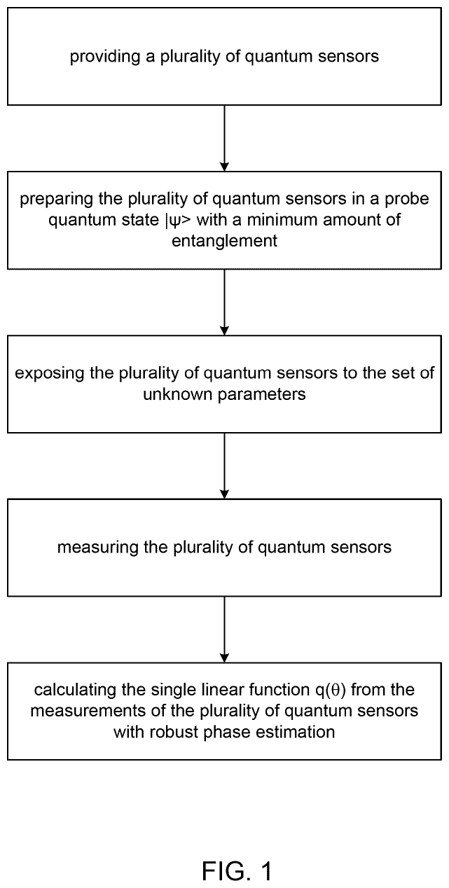

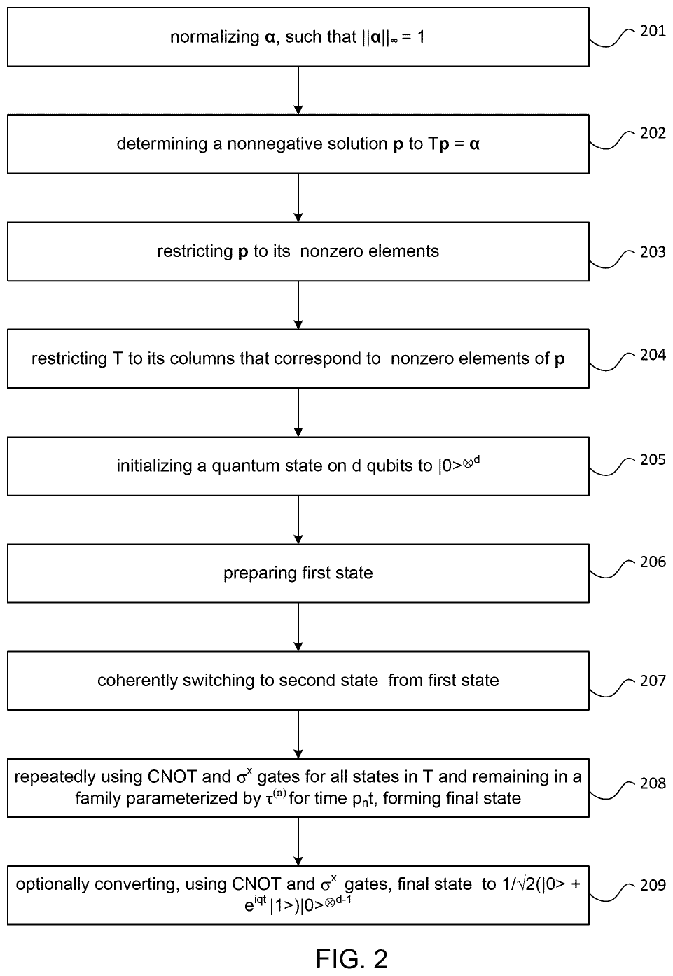

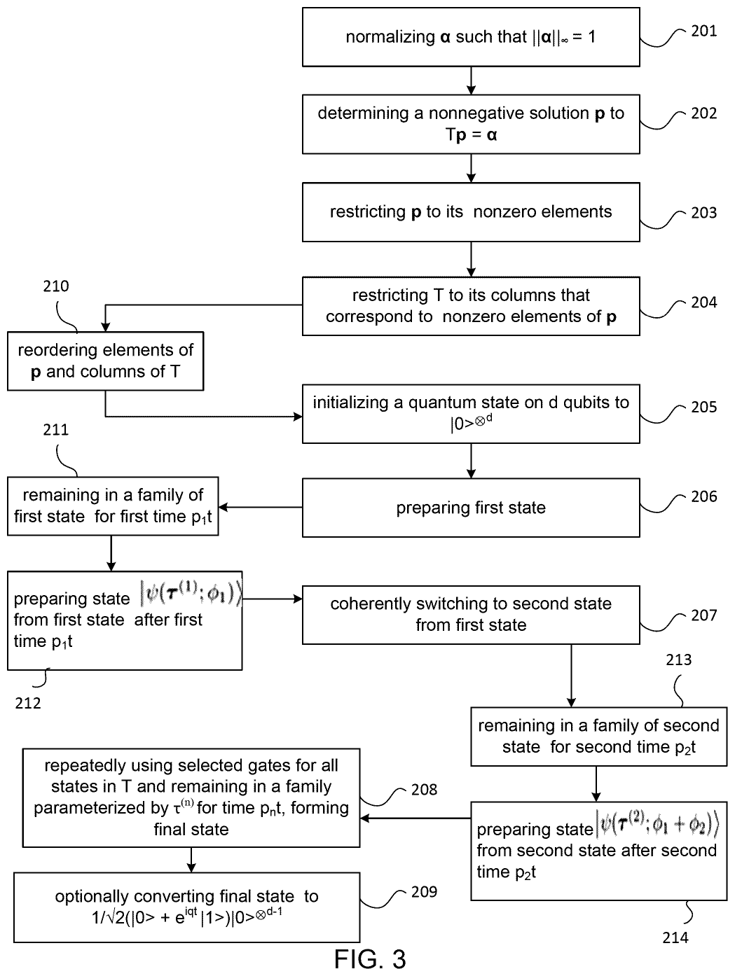

In an embodiment, with reference to FIG. 1, FIG. 2, and FIG. 3, a process for measuring a single linear function q(θ1, θ2, . . . , θd) of unknown parameters {θ1, θ2, . . . , θd} with a quantum sensor network while using the minimum amount of entanglement includes: providing a plurality of d quantum sensors, wherein each quantum sensor j is configured for measuring θj, preparing the plurality of quantum sensors in a probe quantum state |Ψ> with a minimum amount of entanglement, such that the amount of entanglement is the smallest amount of entanglement that gives the same optimal measurement of the linear function q(θ) as if the amount of entanglement was not restricted; exposing the plurality of quantum sensors to the set of unknown parameters; measuring the plurality of quantum sensors; and calculating the single linear function qθ1, θ2, . . . , θd) from the measurements of the plurality of quantum sensors with robust phase estimation. The process of claim 1, wherein calculating the single linear function q(θ1, θ2, . . . , θd) comprises embedding the single linear function q(θ1, θ2, . . . , θd) into relative phase of probe quantum state |Ψ>. In an embodiment, the plurality of quantum sensors is arranged in a network. In an embodiment, the plurality of quantum sensors is qubits, interferometers, or field-quadrature displacement sensors. In an embodiment, the set of unknown parameters is a set of field amplitudes, a set of temperatures, a set of pressures, a set of strains, a set of forces, a set of magnetic fields, a set of electric fields, or a set of gravitational fields.

In an embodiment, the process for measuring a single linear function q(θ1, θ2, . . . , θd) of unknown parameters {θ1, θ2, . . . , θd} with a quantum sensor network while using the minimum amount of entanglement includes: normalizing α, for α∈ [symbol] ^{d}, such that ∥α∥∞=1 (step 201); determining a nonnegative solution p to Tp=α (step 202); restricting p to its N̅ nonzero elements (step 203); restricting T to its columns that correspond to N̅ nonzero elements of p (step 204); initializing a quantum state on d qubits to |0>⊗^{d} (step 205); preparing first state |ψ(τ⁽¹⁾; 0) [symbol] (step 206); coherently switching to second state |ψ(τ⁽²⁾ϕ₁) [symbol] from first state |ψ(τ⁽¹⁾; 0) [symbol] (step 207); repeatedly using CNOT and \hat{σ}^{x} gates for all states in T and remaining in a family parameterized by τ⁽ⁿ⁾ for time pₙt, forming final state |ψ(τ^{its N̅)}; qt) [symbol] (step 208); and optionally converting, using CNOT and \hat{σ}^{x} gates, final state |ψ(τ^{(its N̅)}; qt) [symbol] to 1/\sqrt{2}(|0>+e^{iqt}|1>)|0>⊗^{d} (step 209). In an embodiment, after restricting p (step 203) and restricting T (step 204), reordering elements of p and columns of T (step 210), wherein its N̅ τ corresponding to the columns of T are families of states used in the protocol. In an embodiment, preparing first state |ψ(τ⁽¹⁾; 0) [symbol] occurs in response to using CNOT and \hat{σ}^{x} gates. In an embodiment, the process can include remaining in a family of first state |ψ(τ⁽¹⁾; 0) [symbol] for first time p₁t (step 211), wherein first time p₁t is an amount of time required by the current step of the robust phase estimation protocol. The process of claim 6, further comprising preparing state |ψ(τ⁽¹⁾; ϕ₁) [symbol] from first state |ψ(τ⁽¹⁾; 0) [symbol] after first time p₁t, wherein ϕ₁=Σⱼp₁tτⱼ⁽¹⁾θⱼ (step 212). In an embodiment, coherently switching to second state |ψ(τ⁽²⁾; ϕ₁) [symbol] occurs in response to using CNOT and \hat{σ}^{x} gates. In an embodiment, the process includes remaining in a family of second state |ψ(τ⁽²⁾; ϕ₁) [symbol] for second time p₂t (step 213). The process of claim 9, further comprising preparing state |ψ(τ⁽²⁾; ϕ₁+ϕ₂) [symbol] from second state |ψ(τ⁽²⁾; ϕ₁) [symbol] after second time p₂t, wherein ϕ₂=Σⱼp₂tτⱼ⁽²⁾θⱼ (step 214). In an embodiment, determining the nonnegative solution p (step 202) includes making the determination from experimental desiderata or an optimization algorithm. In an embodiment, the process includes final state |ψ(τ^{(N̅)}; qt) [symbol] is measured according to robust phase estimation that extracts single linear function q(θ1, θ2, . . . , θd) with optimal scaling up to a constant factor. In an embodiment, the process includes skipping step 209 and instead measuring the phase from final state |ψ(τ^{(N̅)}; qt) [symbol] using single-qubit measurements; and computing a parity in an absence of converting, using CNOT and \hat{σ}^{x} gates, final state |ψ(τ^{(N̅)}; qt) [symbol] to 1/\sqrt{2}(|0>+e^{iqt}|1>)|0>⊗^{d}.

In an embodiment, embedding single linear function q(θ1, θ2, . . . , θd) includes: normalizing α, for α∈ [symbol] ^{d}, such that ∥α∥∞=1 (step 201); determining a nonnegative solution p to Tp=α (step 202); restricting p to its N̅ nonzero elements (step 203); restricting T to its columns that correspond to Ñ nonzero elements of p (step 204); optionally reordering elements of p and columns of T (step 210, after step 203 and step 204), wherein N̅ τ corresponding to the columns of T are families of states used in the protocol (in view of step 203 and step 204); initializing a quantum state on d qubits to |0>⊗^{d} (step 205); preparing first state |ψ(τ⁽¹⁾; 0) [symbol] (step 206), wherein preparing first state |ψ(τ⁽¹⁾; 0) [symbol] occurs in response to using CNOT and \hat{σ}^{x} gates; remaining in a family of first state |ψ(τ⁽¹⁾; 0) [symbol] for first time p₁t (step 211), wherein t is the time required by the current step of the robust phase estimation protocol; preparing state |ψ(τ⁽¹⁾; ϕ₁) [symbol] from first state |ψ(τ⁽¹⁾; 0) [symbol] after first time p₁t, wherein ϕ₁=Σⱼp₁tτⱼ⁽¹⁾θⱼ (step 212); coherently switching to second state |ψ(τ⁽¹⁾; ϕ₁) [symbol] from first state |ψ(τ⁽¹⁾; 0) [symbol] (step 207), wherein coherently switching to second state |ψ(τ⁽²⁾; 99 ₁) [symbol] occurs in response to using CNOT and \hat{σ}^{x} gates; remaining in a family of second state |ψ(τ⁽²⁾; 99 ₁) [symbol] for second time p₂t (step 213); preparing state |ψ(τ⁽²⁾; ϕ₁+ϕ₂) [symbol] from second state |ψ(τ⁽²⁾; ϕ₁) [symbol] after second time p₂t, wherein ϕ₂=Σⱼp₂tτⱼ⁽²⁾θⱼ (step 214); repeatedly using CNOT and \hat{σ}^{x} gates for all states in the restricted T and remaining in a family parameterized by τ⁽ⁿ⁾ for time pₙt, forming final state |ψ(τ^{(N̅)}; qt) [symbol] (step 208); and converting, using CNOT and ô^{x} gates, final state |ψ(τ^{(N̅)}; qt) [symbol] to 1/\sqrt{2}(|0>+e^{iqt}|1>)|0>⊗^{d}. (step 209).

In an embodiment, determining the nonnegative solution p (step 202) includes making the determination from experimental desiderata or optimization algorithm. With respect to experimental desiderata and optimization mentioned in step 202, Theorem 1 described below provides conditions on α under which the optimal measurement can be determined with k-partite entanglement, wherein k can be smaller than d. Once the minimum possible k is computed via Theorem 1, one keeps in matrix T only states that have at most k-partite entanglement. One then solves Tp=α for p.

Final state |ψ(τ^{(N̅)}; qt) [symbol] can be measured according to the current stage of the robust phase estimation protocol, which extracts single linear function q(θ1, θ2, . . . , θd) with optimal scaling up to a constant factor.

In an embodiment, the process can include skipping step 209 and instead measuring the phase from final state |ψ(τ^{(N̅)}; qt) [symbol] using single-qubit measurements and computing an appropriate parity as described in U.S. patent application Ser. No. 15/650,216, which is incorporated by reference herein in its entirety.

In addition to the size of the most-entangled state, one can minimize the average entanglement. The average entanglement can be given by weighting the size of each entangled state by the proportion of time that the state is used in the protocol. A proof that there exists a class of protocols that minimize this average entanglement is provided herein. These protocols are non-echoed, wherein the contribution to the relative phase proportional to ei is accumulated with the correct sign corresponding to sgn(αᵢ) such that one need not echo away sensitivity. To obtain such a solution, one can further restrict T to include only columns such that sgn(Tᵢⱼ)=sgn(αᵢ) for all i,j and then solve the corresponding system of linear equations.

It is contemplated that resources besides entanglement can be included in a cost function ε(p), which selects certain solutions to the system of linear equations T^{(k)}p=α. In an embodiment, if certain pairs of quantum sensors are easier to entangle than other quantum sensors, e.g., because of their relative spatial location in quantum sensor network 200, such is encoded into ε(p).

Other optimizations take into consideration ordering of states used in the protocol. In an embodiment, because the protocol involves coherently applying CNOT gates to move between different families of entangled states, and these gates may be error-prone or costly resources, another protocol minimizes use of these gates, which is described below along with tradeoffs between minimizing entanglement and CNOT gates. In an embodiment, a greedy algorithm yields a favorable Θ(d) CNOT cost.

Without wishing to be bound by theory, it is believed that the quantum Cramér-Rao bound (QCRB) is a fundamental limit on the accuracy of unbiased parameter estimation in quantum systems. QCRB states that the variance of any unbiased estimator of a parameter is bounded below by the inverse of the quantum Fisher information (QFI). The QFI is a measure of how much information a quantum state contains about a parameter. QFI is the variance of the symmetric logarithmic derivative (SLD) of the state with respect to the parameter. SLD is an operator that measures how the state changes as the parameter is varied. QCRB can be used to set a lower bound on the uncertainty in any unbiased estimator of a parameter. QCRB has implications for quantum metrology, which is the field of study that deals with the use of quantum systems to make measurements. QCRB shows that quantum systems can be used to achieve higher precision measurements than classical systems because quantum states can contain more information about a parameter than classical states. It should be appreciated that QCRB has been used to develop new quantum sensing protocols, including protocols for measuring the phase of a light beam with unprecedented precision. QCRB is a powerful tool for understanding the limits of quantum parameter estimation ad for developing new quantum sensing protocols.

In an embodiment, quantum sensor network 200 includes: a plurality of quantum sensors, each quantum sensor j is configured for measuring θj out of a set of unknown parameters {θ1, θ2, . . . , θd}, such that the plurality of quantum sensors is configured to be in a probe quantum state |Ψ> with a minimum amount of entanglement, such that the amount of entanglement is the smallest amount of entanglement that gives the same optimal measurement of the linear function q(θ1, θ2, . . . , θd) as if the amount of entanglement was not restricted; a network topology that connects the plurality of quantum sensors; and a controller that is configured to: prepare the plurality of quantum sensors in the probe quantum state |Ψ>; expose the plurality of quantum sensors to the set of unknown parameters; measure the plurality of quantum sensors; and use the measurements of the plurality of quantum sensors to calculate the single linear function q(θ1, θ2, . . . , θd) of the set of unknown parameters. In an embodiment, the plurality of quantum sensors is arranged in a linear array. In an embodiment, the plurality of quantum sensors is arranged in a two-dimensional array. In an embodiment, the plurality of quantum sensors is arranged in a three-dimensional array. In an embodiment, the plurality of quantum sensors is qubits, interferometers, or field-quadrature displacement sensors. In an embodiment, the set of unknown parameters is a set of field amplitudes, a set of temperatures, a set of pressures, a set of strains, a set of forces, a set of magnetic fields, a set of electric fields, or a set of gravitational fields.

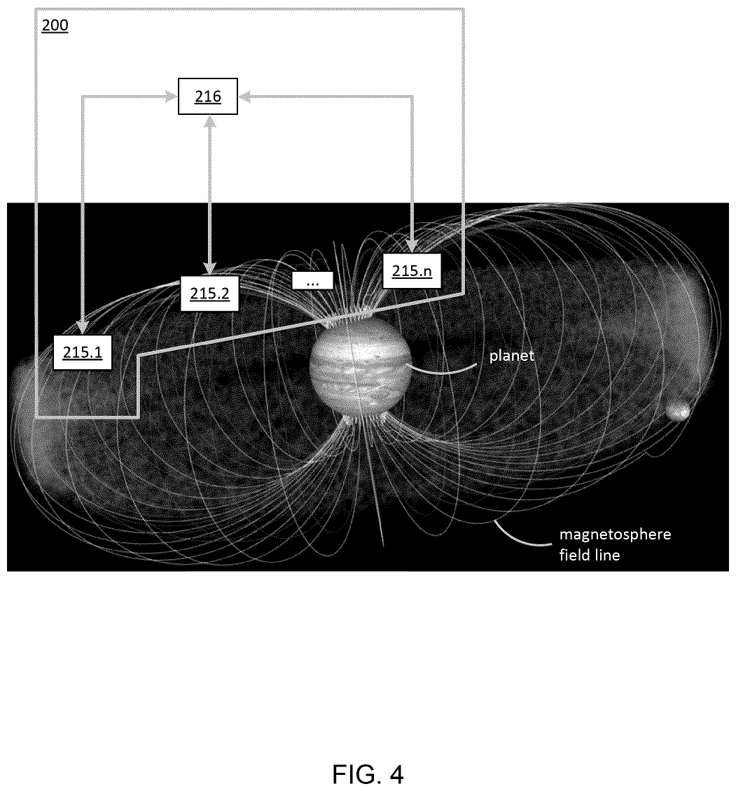

Quantum sensor network 200 can include a plurality of quantum sensors 215 that can include a two-level quantum system such as provided by qubits, a three-level quantum system such as provided by qutrits, a four-level quantum system, . . . , an m-level quantum system and the like, wherein m is an integer. It is contemplated that energy differences are measured between two levels so certain embodiments are described in the context of qubits. Exemplary quantum sensors 215 include a nuclear spin, an electronic spin, any two chosen levels of a neutral atom, an ion, a molecule, a solid-state defect, a superconducting qubit, and the like. In an embodiment, quantum sensors 215 include a neutral atom, an ion, a molecule, a solid-state defect (such as color center in diamond), a superconducting circuit, and the like, or a combination thereof. The energy differences between the two levels of each qubit quantum sensor can depend linearly on an observable of interest such as an electric field, a magnetic field, a gravitational field, temperature, strain, and the like. These observables of interest can be produced by an analyte that can include a planet, an organism (e.g., a human), an organ (e.g., a brain or a heart), a tissue (e.g., cardiac tissue), a laser, a molecule (e.g., including macromolecule such as a protein or a nucleic acid), an atom, and the like. FIG. 4 shows an embodiment wherein quantum sensor network 200 includes quantum sensors 215 in communication with controller 216, wherein quantum sensors 215 are disposed in a magnetosphere of a planet so that quantum sensor network 200 determines a spatial distribution of magnetic field strength and direction in some reference frame.

In an embodiment, quantum sensor 215 is an interferometer including a path that goes through the medium of interest and picks up a phase and a reference path that doesn't pick up a phase. The medium of interest can include a tissue, a cell, or any other medium that transmits light. In the case of field-quadrature displacement sensors, quantum sensors 215 can include a bosonic mode that undergoes a field-quadrature displacement and a homodyne detector used to measure this field quadrature. The bosonic mode can describe mechanical motion where the parameters coupled to mode can be proportional to a force. The bosonic mode can describe photons where the parameters coupled to the mode can be proportional to a magnetic field via Faraday-rotation after passing through the medium. The bosonic mode can describe low-energy excitations of a large number of two-level atoms where the parameters coupled to the mode can be proportional to an applied electric or magnetic field.

In an embodiment, a process for making quantum sensor network 200 that measures single linear function q(θ1, θ2, . . . , θd) includes: providing a plurality of quantum sensors 215; arranging the plurality of quantum sensors 215 in a network topology, such that each quantum sensor j is configured for measuring θj out of a set of unknown parameters θ={θ1, θ2, . . . , θd}; connecting the plurality of quantum sensors to a controller; and preparing, by the controller, the plurality of quantum sensors in a probe quantum state |Ψ> with a minimum amount of entanglement, such that the amount of entanglement is the smallest amount of entanglement that gives the same optimal measurement of the linear function q(θ) as if the amount of entanglement was not restricted. In an embodiment, the plurality of quantum sensors is arranged in a linear array. In an embodiment, the plurality of quantum sensors is arranged in a two-dimensional array. In an embodiment, the plurality of quantum sensors is arranged in a three-dimensional array. In an embodiment, the plurality of quantum sensors is qubits, interferometers, or field-quadrature displacement sensors. In an embodiment, the network topology is a star topology, a ring topology, or a mesh topology. In an embodiment, the controller is a classical computer.

It is contemplated that quantum sensor network 200 and measuring a single linear function q(θ1, θ2, . . . , θd) of unknown parameters {θ1, θ2, . . . , θd} with a quantum sensor network while using the minimum amount of entanglement can include the properties, functionality, hardware, and process steps described herein and embodied in any of the following non-exhaustive list:
a process (e.g., a computer-implemented method including various steps; or a method carried out by a computer including various steps);
an apparatus, device, or system (e.g., a data processing apparatus, device, or system including means for carrying out such various steps of the process; a data processing apparatus, device, or system including means or carrying out various steps; a data processing apparatus, device, or system including a processor adapted to or configured to perform such various steps of the process);
a computer program product (e.g., a computer program product including instructions which, when the program is executed by a computer, cause the computer to carry out such various steps of the process; a computer program product including instructions which, when the program is executed by a computer, cause the computer to carry out various steps);
computer-readable storage medium or data carrier (e.g., a computer-readable storage medium including instructions which, when executed by a computer, cause the computer to carry out such various steps of the process; a computer-readable storage medium including instructions which, when executed by a computer, cause the computer to carry out various steps; a computer-readable data carrier having stored thereon the computer program product; a data carrier signal carrying the computer program product);
a computer program product including comprising instructions which, when the program is executed by a first computer, cause the first computer to encode data by performing certain steps and to transmit the encoded data to a second computer; or
a computer program product including instructions which, when the program is executed by a second computer, cause the second computer to receive encoded data from a first computer and decode the received data by performing certain steps.

Entanglement is a hallmark of quantum theory and plays an essential role in certain quantum technologies. In single-parameter metrology one seeks to determine an unknown phase θ that is independently and identically coupled to d sensors via a linear Hamiltonian Ĥ. Given a probe state \hat{ρ}, evolution under Ĥ encodes θ into \hat{ρ} where it can then be measured. If the sensors are classically correlated the ultimate attainable uncertainty is the standard quantum limit Δθ˜1/\sqrt{d}, which can be surpassed only if the states are prepared in an entangled state. If O(d)-partite entanglement is used, the Heisenberg limit Δθ˜1/d can be achieved. Entanglement for optimal measurement has been explored in sequential measurement schemes, wherein one applies the encoding unitary multiple times in the presence of decoherence when the coupling Hamiltonian is non-linear or in reference to resource theories for metrology.

Consider the amount of entanglement required to saturate the quantum Cramér-Rao bound, which provides a lower bound of the variance of measuring an unknown quantity, in the prototypical multiparameter setting of a quantum sensor network, where d independent, unknown parameters θ (boldface denotes vectors) are each coupled to a unique quantum sensor. Specifically, consider optimally measuring a single linear function q(θ), which is an element of optimal protocols for more general quantum sensor network problems. It should be appreciated that the case of measuring one or multiple analytic functions and the case where the parameters θ are not independent reduce asymptotically to the linear problem considered here. Embodiments herein include measuring a single linear function of independent parameters.

Given the similarity of measuring a single linear function to the single-parameter case and the fact that such functions of local parameters are global properties of the system, provided all the local parameters non-trivially appear in q, one might intuit that d-partite entanglement is necessary. This intuition is reinforced by the fact that all existing optimal protocols for this problem do, in fact, make use of d-partite entanglement. However, such intuition is faulty and only holds in the case where q is approximately an average of the unknown parameters. In particular, a family of protocols can be used that saturate necessary and sufficient algebraic conditions to achieve optimal performance in this setting. Below is described via proof necessary and sufficient conditions on q for the existence of optimal protocols using at most (k<d)-partite entanglement. The more uniformly distributed q is amongst the unknown parameters, the more entanglement is required. Other resources of interest are considered, such as the number of entangling gates needed to perform these protocols and their optimization via the protocol. Note that certain probabilistic protocols fail to achieve the Heisenberg limit except for a narrow class of functions.

### Problem Setup.

With regard to measuring a linear function of unknown parameters in a quantum sensor network, consider a network of d qubit quantum sensors coupled to d independent, unknown parameters θ∈ [symbol] ^{d} via a Hamiltonian of the form

$$\hat{H} ( s ) = {\sum }_{i = 1}^{d} \frac{1}{2} {θ}_{i} {\hat{σ}}_{i}^{z} + {\hat{H}}_{c} ( s ) , \qquad ( 1 )$$

where \hat{σ}ᵢ^{xyz} are the Pauli operators acting on qubit i and Ĥ_{c}(s) for s∈[0,t] is any choice of time-dependent, θ-independent control Hamiltonian, potentially including coupling to an arbitrary number of ancilla. That is, Ĥ_{c}(s) accounts for any possible parameter-independent contributions to the Hamiltonian, including those acting on any extended Hilbert space with a (finite) dimension larger than that of the network of d qubit sensors directly coupled to the unknown parameters. Encode the parameters θ into a quantum state \hat{ρ} via the unitary evolution generated by a Hamiltonian of this form for a time t. Given some choices of initial probe state, control Ĥ_{c}(s), final measurement, and classical post-processing, we seek to construct an estimator for a linear combination q(θ)=α·θ of the unknown parameters, where α∈ [symbol] ^{d} is a set of known coefficients, and we assume without loss of generality that ∥α∥∞=|α₁|. U.S. Pat. No. 10,007,885 is incorporated by reference herein in its entirety and describes a fundamental limit for the mean square error [symbol] of an estimator for q is

$$ℳ \geq \frac{{‖ α ‖}_{∞}^{2}}{{t}^{2}} , \qquad ( 2 )$$

wherein t is the total evolution time.

Eq. (2) is derived via the single-parameter quantum Cramér-Rao bound. This is surprising because, while one seeks to measure only a single quantity q(θ), d parameters control the evolution under Eq. (1), so it does not a priori satisfy conditions for use of the single-parameter quantum Cramér-Rao bound. However, one can justify its validity for our system such that one considers an infinite set of imaginary scenarios, wherein each corresponds to a choice of artificially fixing d−1 degrees of freedom and leaving only q(θ) free to vary. Under any such choice, our final quantum state depends on a single parameter q, and we can apply the single-parameter quantum Cramér-Rao bound. While this involves giving oneself information that one does not have, additional information can only reduce [symbol] , and, therefore, any such choice provides a lower bound on [symbol] when one does not have such information. To obtain the tightest possible bound there must be some choice of artificially fixing d−1 degrees of freedom that gives no (useful) information about q(θ). Algebraic conditions are derived that characterize such choices.

One applies the single-parameter quantum Cramér-Rao bound

$$ℳ \geq \frac{1}{ℱ ( q )} \geq \frac{1}{{t}^{2} {‖ {\hat{g}}_{q} ‖}_{s}^{2}} , \qquad ( 3 )$$

wherein [symbol] is the quantum Fisher information, ĝ_{q}=∂Ĥ/∂\hat{q} (the partial derivative fixes the other d−1 degrees of freedom), and the seminorm ∥ĝ_{q}∥ₛ is the difference of the largest and smallest eigenvalues of ĝ_{q}. A choice of fixing extra degrees of freedom, yielding the tightest bound via Eq. (3), gives ∥ĝ_{q}∥ₛ²=1/∥α∥∞², yielding Eq. (2).

### Conditions for Saturable Bounds.

The above description justifies applying the single-parameter bound in the multiparameter scenario. The quantum Fisher information matrix [symbol] (θ) provides an information-theoretic solution for constructing optimal protocols. When calculating [symbol] (θ), restrict the construction to pure probe states, as the convexity of the quantum Fisher information matrix implies mixed states fail to produce optimal protocols. For pure probe states and unitary evolution for time t under the Hamiltonian in Eq. (1), it has matrix elements

$${ℱ 〈 θ )}_{ij} = 4 [ \frac{1}{2} 〈 \{ {\hat{ℋ}}_{i} ( t ) , {\hat{ℋ}}_{j} ( t ) \} 〉 - 〈 {\hat{ℋ}}_{i} ( t ) 〉 〈 {\hat{ℋ}}_{j} ( t ) 〉 ] , \qquad ( 4 )$$

where {⋅, ⋅} denotes the anti-commutator and

$${\hat{ℋ}}_{i} ( t ) = - {\int }_{0}^{t} ds {\hat{U}}^{†} ( s ) {\hat{g}}_{i} \hat{U ( s ) ,} \qquad ( 5 )$$

with ĝᵢ=∂Ĥ/∂θᵢ=\hat{σ}ᵢ^{z}, and Û the time-ordered exponential of Ĥ. The expectation values in Eq. (4) are taken with respect to the initial probe state.

Choosing d−1 degrees of freedom for using the single-parameter bound corresponds to a basis transformation θ→q, wherein take q₁=q to be a quantity of interest, and the other arbitrary q_{j>1} are extra degrees of freedom. This basis transformation has a corresponding Jacobian J such that [symbol] (q)=J^{T} [symbol] (θ)J. To obtain the bound in Eq. (2) and have no information about q(θ) from the extra degrees of freedom q_{j>1}, [symbol] (q) has the following properties:

$$ℱ {( q )}_{11} = \frac{{t}^{2}}{{α}^{2}} , \qquad ( 6 )$$

$$ℱ {( q )}_{1 i} = ℱ {( q )}_{i 1} = 0 ( ∀ i \neq 1 ) \qquad ( 7 )$$

Without loss of generality, |α₁|=∥α∥∞. Via the inverse basis transformation q→θ, Eqs. (6)-(7) are satisfied if and only if

$${ℱ ( {θ}_{1} )}_{1 j} = {ℱ ( θ )}_{j 1} = \frac{{α}_{j}}{{α}_{1}} {t}^{2} , \qquad ( 8 )$$

where assume that |α₁|>|αⱼ|∀j>1. Theorem 1 is unchanged by this assumption. The explicit derivation of Eq. (8), along with the generalization of results beyond this assumption, is described below.

The problem of function estimation is mathematically equivalent to nuisance parameters in classical and quantum estimation theory. However, embodiments of the protocols and especially their entanglement features are new.

### A Family of Optimal Protocols.

In a family of protocols that achieve Eq. (8), a particular protocol includes preparing a pure initial state \hat{ρ}₀=|Ψ(0)><Ψ(0)|, evolving po under the unitary generated by Ĥ(s) for time t, performing some positive operator-valued measurement, and computing an estimator for q from the measurement outcomes. Given \hat{ρ}₀ and Ĥ_{c}(s), [symbol] (θ) can be computed via Eq. (4).

Protocols use v(s) to coherently switch between probe states with different sensitivities to the unknown parameters θ and accumulate an overall sensitivity to the unknown function of interest q. In particular, consider a set [symbol] of N=3^{d-1} one-parameter families of cat-like states:

$$\vert ψ ( τ ; φ ) 〉 = \frac{1}{\sqrt{2}} ( \vert τ 〉 + {e}^{i φ} \vert - τ 〉 ) , \qquad ( 9 )$$

where each family of states is labeled by a vector τ∈{0,±1}^{d} such that

$$\vert τ 〉 = {{⊗}^{d}}_{j = 1} \{ \begin{matrix}\vert 0 〉 , & {τ}_{j} \neq - 1 \\ \vert 1 〉 , & {τ}_{j} = - 1\end{matrix} , \qquad ( 10 )$$

and φ∈ [symbol] parameterizes individual states in the family. Here τ₁=1, as any optimal protocol is sensitive to this parameter. Each probe state in Eqs. (9) and (10) is a superposition of exactly two states, referred to as branches. These states use no ancilla.

Protocols include starting in a state |Ψ(τ;0)> and using the control Hamiltonian to coherently switch between families of probe states such that the relative phase between the branches is preserved (that is, Ĥ_{c}(s) changes τ, but not φ). This can be done using finitely many CNOT and \hat{σ}^{x} gates. Stay in the family of states |ψ(τ⁽ⁿ⁾; φ) [symbol] for time pₙt, where pₙ∈[0,1] such that Σₙpₙ=1. Here n indexes some enumeration of the families of states in T. There are three possibilities for the relative phase that qubit j induces between the two branches due to the time spent in family n. If τⱼ⁽ⁿ⁾=0, then no relative phase is accrued because qubit j is disentangled. If τⱼ⁽ⁿ⁾=1, the relative phase imprinted by \hat{σ}ⱼ^{z}/2 is pₙθⱼt, while if τⱼ⁽ⁿ⁾=−1, the relative phase is −pₙθⱼt. Thus, the j-th qubit always induces a relative phase of pₙτ⁽ⁿ⁾θⱼt. Accounting for all qubits, being in family n for time pₙt induces a relative phase

$${ϕ}_{n} = {\sum }_{j} {p}_{n} t {τ}_{j}^{( n )} {θ}_{j} . \qquad ( 11 )$$

Given some time-dependent probe |Ψ(t)> which is in the family |ψ(τⁿ⁾; φ) [symbol] for time pₙt, the total phase ϕ accumulated between the branches is

$$ϕ = {\sum }_{n} {ϕ}_{n} = {\sum }_{n} {\sum }_{j} {p}_{n} t {τ}_{j}^{( n )} {θ}_{j} = {\sum }_{j} {( T p )}_{j} {θ}_{j} t , \qquad ( 12 )$$

where implicitly defined p=(p₁, . . . ,p_{N})^{T}, and d×N matrix T with matrix elements Tₘₙ= [symbol] ₘ⁽ⁿ⁾. If p is chosen such that Tp∝α this total phase is ∝qt. More formally, choosing p such that

$$Tp = \frac{α}{{α}_{1}} \qquad ( 13 )$$

achieves the saturability condition in Eq. (8), yielding a provably optimal protocol.

Any nonnegative solution (in the sense that pₙ≥0 ∀n) to Eq. (13) specifies a valid set of states and evolution times satisfying Eq. (8). Because the system in Eq. (13) is highly under constrained, such protocols do not necessarily use all 3^{d-1} families of states in [symbol] .

From a solution to Eq. (13), provide a measurement scheme to extract information about q that includes: applying a sequence of \hat{σ}^{x} and CNOT gates to the final state of a protocol to transform it into 1/\sqrt{2}(|0>+e^{iqt/α1}|1>)(|0 . . . 0>). Then, perform single qubit phase estimation to measure q.

Such phase estimation is not as simple as it might appear. Because one is interested in how the error scales in the t→∞ limit, a naive approach loses track of which 2π interval the phase is in. One could assume that this information is known a priori, but this is unjustified as the knowledge is of precision ˜|α₁|/t, i.e., it is already within the Heisenberg limit. More realistically, starting with any t-independent prior knowledge of the unknown phase, use the phase estimation protocols to saturate Eq. (2) up to a modest constant factor.

### Minimum Entanglement Solutions.

Consider solutions from the family of protocols that involve the minimum amount of entanglement. Described is a necessary and sufficient condition on a for existence of a protocol that uses at most k-partite entanglement. The protocols above use a particular choice of controls that does not include ancilla qubits, and Theorem 1 applies to any protocol making use of a Hamiltonian described via Eq. (1).

Theorem 1. Let q(θ)=α·θ. Without loss of generality, let ∥α∥∞=|α₁|. Let k∈ [symbol] ⁺ so that

$$k - 1 < \frac{{‖ α ‖}_{1}}{{‖ α ‖}_{∞}} \leq k . \qquad ( 14 )$$

An optimal protocol to estimate q(θ), where the parameters θ are encoded into the probe state via unitary evolution under the Hamiltonian in Eq. (1) requires at least, but no more than, k-partite entanglement.

Theorem 1 justifies d-partite entanglement is not necessary unless |α|₁ is large enough, i.e., in the case of measuring an average (αᵢ=1/d−∀i). Using k-partite entangled states from the set of cat-like states considered above, there exists an optimal protocol, subject to the upper bound of Eq. (14). Subject to the conditions in the theorem statement, there exists no optimal protocol using at most (k−1)-partite entanglement, proving the lower bound of Eq. (14).

Part 1. Define T^{(k)} to be the submatrix of T with all columns n such that Σₘ|Tₘₙ|>k are eliminated, which enforces that any protocol derived from T^{(k)} uses only states that are at most k-partite entangled. Define System A(k) as

$${T}^{( k )} {p}^{( k )} = α / α 1 , \qquad ( 15 )$$

$${p}^{( k )} \geq 0. \qquad ( 16 )$$

Let α′=α/α₁ and define System B(k) as

$${( {T}^{( k )} )}^{T} y \geq 0 , \qquad ( 17 )$$

$$< {α}^{′} , y > < 0. \qquad ( 18 )$$

By the Farkas-Minkowski lemma, System A(k) has a solution if and only if System B(k) does not, so it is sufficient to show that System B(k) does not have a solution if Σ_{j>1}|αⱼ′|≤k−1, where we used that α₁′=1. This can be shown by contradiction.

Part 2. The probe state must always be maximally sensitive to the first sensor qubit, so [symbol] (θ)₁ⱼ only accumulates in magnitude when qubit j is entangled with the first qubit (Eq. (4) is similar to a connected correlator). Using this, satisfying the condition in Eq. (8) requires ∥α∥₁/∥α∥∞>k−1.

Theorem 1 provides conditions for the existence of solutions to Eq. (13) with limited entanglement, but it is not constructive. To obtain an explicit protocol, solve the system of linear equations T^{(k)}p=α. One might wish to minimize the size of the most-entangled state and the average entanglement used (given by weighting the size of each entangled state by the proportion of time that the state is used in the protocol). Below is shown that there exists a class of protocols that minimizes this average entanglement. These protocols are non-echoed in the sense that the contribution to the relative phase proportional to θᵢ is always accumulated with the correct sign corresponding to sgn(αᵢ) such that one need not echo away any sensitivity. To obtain such a solution, one can further restrict T to only include columns such that sgn(Tᵢⱼ)=sgn(αᵢ) for all i,j and then solve the corresponding system of linear equations. Resources besides entanglement may be of interest and can included in a cost function ε(p), which selects certain solutions to the system of linear equations T^{(k)}p=α. For example, if certain pairs of sensors are easier to entangle than others, due, for instance, to their relative spatial location in the network, that could be encoded into ε(p). Some optimizations can include ordering of the states used in the protocols. For example, because certain protocols involve coherently applying CNOT gates to move between different families of entangled states, and these gates may be error-prone or costly resources, one can find protocols that minimize the usage of these gates, which is described below along with potential tradeoffs between minimizing entanglement and CNOT gates.

### Time-Independent Protocols.

Another approach to constructing optimal protocols is to use so-called probabilistic protocols. These protocols eschew optimal control and instead exploit the convexity of the quantum Fisher information to pick states from the families [symbol] with frequencies specified by a solution to Eq. (13) in order to generate a Fisher information matrix satisfying Eq. (8). These protocols have the advantage of requiring no control but can suffer worse scaling with d than the above protocol for generic functions when the available resources are comparable. Consider a probabilistic protocol that makes use of N̅ states from distinct families in [symbol] . Each of these states is sensitive to a different function qⱼ such that q=Σⱼpⱼqⱼ. Each qⱼ is encoded in the relative phase between the two branches of the corresponding state. Learning each qⱼ is allotted tⱼ time, where Σⱼtⱼ=t. In this scenario, it is impossible to achieve the saturability condition of Eq. (8) as for a probabilistic protocol [symbol] (θ)₁₁≤t²/N̅². If we only care about saturability up to a constant then these time-independent protocols still achieve optimal scaling with d when N̅=O(1). However, for general functions N̅ scales nontrivially with d and, consequently, probabilistic protocols fail to achieve optimal scaling.

In view of the foregoing, it should be appreciated that maximally entangled states are not necessary for the optimal measurement of a linear function with a quantum sensor network unless the function is sufficiently uniformly supported on the unknown parameters. This result, combined with the general framework of optimizing protocols subject to practical constraints, can be used in quantum sensor networks, wherein creating large-scale entangled states may be challenging. These results are useful in more general settings, such as measurement of analytic functions, as these measurements reduce to certain embodiments herein.

With regard to being constrained to k-partite entanglement with k not sufficient to achieve optimality (for any protocol) via Theorem 1, a protocol for such a scenario includes: letting R be a partition of quantum sensors into independent sets and do not allow entanglement between sets and allow, at most, k-partite entanglement within each r∈R. Let α^{(r)} denote a restricted to r. Pick the optimal R such that the condition of Theorem 1 is satisfied for all r; that is, ensure that within each independent set is obtained the optimal variance for the linear function restricted to that set. The result is a variance

$$ℳ = \frac{1}{{t}^{2}} {\sum }_{r ∈ R} {‖ {α}^{( r )} ‖}_{∞}^{2} . \qquad ( 19 )$$

The optimal R is a partition of the sensors into contiguous sets (assuming for simplicity that |αᵢ|≥|αⱼ| for i<j) such that for all r∈R, Σ_{i∈r}|αᵢ|/max_{i∈r}|αᵢ|≤k, satisfying Theorem 1. Conjecture that this protocol is optimal, and it is so if partitioning the problem into independent sets is optimal. However, one could imagine protocols that use different partitions for some fraction of the time. Intuitively, this should not improve the performance.

Finally, no optimal time-independent protocols for arbitrary linear functions exist in the literature.

### Summary of Phase Embedding Protocol.

Protocols include embedding the function q=α·θ into the relative phase of a probe quantum state |Ψ>:

$$\vert ψ 〉 ⟶ \frac{1}{\sqrt{2}} ( \vert 0 〉 + {e}^{iqt / {‖ α ‖}_{∞}} \vert 1 〉 ) \vert 0 … 0 〉 . \qquad ( S1 )$$

The phase embedding algorithm is a subprotocol of the full protocol for function estimation, which involves embedding q into many copies of a quantum state to perform the robust phase estimation.

Probe states from Eqs. (9)-(10) are repeated here:

$$\vert ψ ( τ ; φ ) 〉 = \frac{1}{\sqrt{2}} ( \vert τ 〉 + {e}^{i φ} \vert - τ 〉 ) , \qquad ( S2 )$$

$$\vert τ 〉 = {{⊗}^{d}}_{j = 1} \{ \begin{matrix}\vert 0 〉 , & {τ}_{j} \neq - 1 \\ \vert 1 〉 , & {τ}_{j} = - 1\end{matrix} . \qquad ( S3 )$$

φ∈ [symbol] parameterizes individual states in the family, and τ₁=1. The form of these states is rigorously justified by Lemma S1 in Sec. S2. We embed the τ into a d×N (N=3^{d-1}) matrix T with matrix elements Tₘₙ= [symbol] ₘ⁽ⁿ⁾ for some ordering of the τ.

The protocol proceeds as follows: given α∈ [symbol] ^{d}, normalize it such that ∥α∥∞=1; using any relevant experimental desiderata and optimization algorithm, find a nonnegative solution p to Tp=α; restrict p to its N̅ nonzero elements, and restrict T to the corresponding columns, and if desired, reorder the elements of p and the columns of T, wherein the N̅ τ corresponding to the columns of T are the families of states used in the protocol; initialize a quantum state on d qubits to |0>⊗^{d}; using CNOT and \hat{σ}^{x} gates, prepare |ψ(τ⁽¹⁾; 0) [symbol] , the first state of the protocol, and remain in this family for time p₁t, leading to state |ψ(τ⁽¹⁾; ϕ₁) [symbol] , wherein ϕ₁=Σⱼp₁tτⱼ⁽¹⁾θⱼ, and here t is the time required by the current step of the robust phase estimation protocol; using CNOT and \hat{σ}^{x} gates, coherently switch to |ψ(τ⁽²⁾; ϕ₁) [symbol] from |ψ(τ⁽¹⁾; ϕ₁) [symbol] , and remain in this family for time p₂t, leading to state |ψ(τ⁽²⁾; ϕ₁+ϕ₂) [symbol] , with ϕ₂Σⱼp₂tτⱼ⁽²⁾θⱼ; repeat this process for all states in the restricted T, staying in the family parameterized by τ⁽ⁿ⁾ for time pₙt, leading to a final state |ψ(τ^{(N̅)}; qt) [symbol] ; and optionally using CNOT and \hat{σ}^{x} gates, convert this final state to 1/\sqrt{2}(|0>+e^{iqt}|1>)|0>⊗^{d}.

This final state can then be measured according to the current stage of the robust phase estimation protocol, which eventually allows one to extract q with optimal scaling up to a constant factor.

### Lemma Regarding Optimal Probe States.

Here is proved a lemma restricting the structure of the probe state for an optimal protocol.

Lemma S1. Any optimal protocol, independent of the choice of control, requires that < [symbol] (t)>=0, where [symbol] (t) is the time-evolved generator of the first parameter and the expectation value is taken with respect to the initial probe state. Further the probe state must be of the form

$$\vert ψ 〉 = \frac{\vert 0 〉 \vert {φ}_{0} 〉 + {e}^{i ϕ} \vert 1 〉 \vert {φ}_{1} 〉}{\sqrt{2}} , \qquad ( S 4 )$$

for all times s∈[0,t], where ϕ, |φ₀>, |φ₁> are arbitrary states on the d−1 remaining sensor qubits plus, perhaps, the arbitrary number of ancilla can be s-dependent.

Proof. Consider the expression for the matrix elements of the quantum Fisher information matrix at time t (Eq. (4)):

$${ℱ ( θ )}_{ij} = 4 [ \frac{1}{2} 〈 \{ {\hat{ℋ}}_{i} ( t ) , {\hat{ℋ}}_{j} ( t ) \} 〉 - 〈 {\hat{ℋ}}_{i} ( t ) 〉 〈 {\hat{ℋ}}_{j} ( t ) 〉 ] , \qquad ( S 5 )$$

where the expectation values are taken with respect to the initial probe state |Ψ(0)>. Using the integral form of [symbol] (t) (Eq. (5) of the main text),

$${ℱ ( θ )}_{11} = 4 Var [ {\hat{ℋ}}_{1} ( t ) ] = \begin{matrix}4 [ {\int }_{0}^{t} ds {\int }_{0}^{t} {ds}^{′} 〈 ψ ( 0 ) \vert {U}^{†} ( s ) {\hat{g}}_{1} \\ U ( s ) {U}^{†} ( {s}^{′} ) {\hat{g}}_{1} U ( {s}^{′} ) \vert ψ ( 0 ) 〉 ]\end{matrix} \qquad ( S 6 )$$

$$- {4 [ {\int }_{0}^{t} ds 〈 ψ ( 0 ) \vert {U}^{†} ( s ) {\hat{g}}_{1} U ( s ) \vert ψ ( 0 ) 〉 ]}^{2} \qquad ( S 7 )$$

$$= 4 {\int }_{0}^{t} ds {\int }_{0}^{t} {ds}^{′} {Cov}_{\vert ψ ( 0 ) 〉} [ {\hat{g}}_{1} ( s ) , {\hat{g}}_{1} ( {s}^{′} ) ] , \qquad ( S 8 )$$

wherein

$$( s ) := {U}^{†} U ( s ) , \qquad ( S 9 )$$

and ĝ₁=∝Ĥ/∝θ₁ is the initial generator with respect to the first parameter. Once again, the covariance is with respect to the initial probe state |Ψ(0)>. The upper bound is

$${ℱ ( θ )}_{11} ( t ) \leq 4 {\int }_{0}^{t} ds {\int }_{0}^{t} {ds}^{′} \sqrt{{Var}_{{\vert ψ ( 0 ) 〉}_{} [ {\hat{g}}_{1} ( s ) ]} {Var}_{{\vert ψ ( 0 ) 〉}_{} [ {\hat{g}}_{1} ( {s}^{′} ) ]}} \qquad ( S10 )$$

$$= {4 [ {\int }_{0}^{t} ds \sqrt{{Var}_{{\vert ψ ( 0 ) 〉}_{} [ {\hat{g}}_{1} ( s ) ]}} ]}^{2} \qquad ( S11 )$$

$$\leq {[ {\int }_{0}^{t} ds {‖ {\hat{g}}_{1} ‖}_{s} ]}^{2} \qquad ( S12 )$$

$$= {t}^{2} {‖ {\hat{g}}_{1} ‖}_{s}^{2} \qquad ( S13 )$$

$$= {t}^{2} , \qquad ( S14 ) ,$$

wherein the first inequality bounds the covariance as the square root of the product of the variances; the second inequality bounds the standard deviation of an operator by half the seminorm, and the final equality uses the fact that ĝ₁=\hat{σ}₁^{z} has seminorm 1.

Via Eq. (8), an optimal protocol has [symbol] ₁₁(θ)(t)=t². Therefore, an optimal protocol must saturate the inequalities in Eq. (S10) and Eq. (S12). Eq. (S12) is saturated when Var[ĝ₁(s)]=∥ĝ₁(s)∥ₛ=∥ĝ₁∥ₛ for all s. This holds if and only if

$$\vert ψ ( 0 ) 〉 = \frac{1}{\sqrt{2}} ( \vert {λ}_{min} 〉 + {e}^{i ϕ} \vert {λ}_{max} 〉 ) ,$$

where |λₘᵢₙ> and |λₘₐₓ> are the eigenstates corresponding to the minimum and maximum eigenvalues of ĝ₁(s) for all s∈[0,t] and ϕ is an arbitrary phase. Given this condition, ĝ₁(s) and ĝ₁(s′) act identically on the state |Ψ(0)> and consequently are fully correlated when one considers the covariance of these operators with respect to the state. The Cauchy-Schwarz inequality in Eq. (S10) is immediately saturated as well.

Under this condition on the probe state, any operator in the one-parameter family ĝ₁(s)=U^{†}(s) ĝ₁U(s) acts identically on |Ψ(0)>. The unitary does not change the eigenvalues, and the eigenstates are shared by all ĝ₁(s). Thus, one can substitute any operator in the one-parameter family ĝ₁(s)=U^{†}(s) ĝ₁U(s) for another. For such an optimal probe state,

$$〈 {ℋ}_{1} ( t ) 〉 = - {\int }_{0}^{t} ds 〈 ψ ( 0 ) \vert {\hat{g}}_{1} ( s ) \vert ψ ( 0 ) 〉 = t 〈 {\hat{g}}_{1} 〉 = 0 \qquad ( S15 )$$

because ĝ₁∝\hat{σ}₁^{z}. Consequently, by replacing ĝ₁by ĝ₁(s) when acting on the probe state,

$$〈 ψ ( s ) \vert {\hat{g}}_{1} \vert ψ ( s ) 〉 = 0 ( ∀ s ) . \qquad ( S16 )$$

The statement of the lemma follows.

Lemma S1 holds for any optimal protocol, including those using cat-like states. It also justifies the choice of probe states and why one sets τ₁=1 for all T, i.e., to maintain an equal superposition between |0> and |1> on the first qubit.

### Proof of the Optimality of Cat-State Protocols.

Optimality of the time-dependent protocols is proven. In particular, the Fisher information matrix condition for saturability in Eq. (8) is satisfied by solutions to Eq. (13) when protocols that use \hat{σ}ₓ and CNOT controls to switch between families of cat-like states in [symbol] . That is, the following mapping occurs between saturability conditions:

$$Tp = \frac{α}{{α}_{1}} ⇒ {ℱ ( θ )}_{1 j} = \frac{α}{{α}_{1}} {t}^{2} , \qquad ( S17 )$$

where one assumes that |α₁|=|αⱼ|∞>|aⱼ| for all j. Text below generalizes beyond the assumption of a single maximum magnitude αⱼ at the cost of some notational inconvenience.

Using Lemma S1, for any optimal protocol, i.e., in addition to cat-like states,

$${ℱ ( θ )}_{1 j} = 2 〈 \{ {\hat{ℋ}}_{1} , {\hat{ℋ}}_{j} \} 〉 \qquad ( S18 )$$

$$= 2 {\int }_{0}^{t} ds {\int }_{0}^{t} {ds}^{′} 〈 ψ ( 0 ) \vert \{ {\hat{g}}_{1} ( s ) , {U}^{†} ( {s}^{′} ) {\hat{g}}_{j} U ( {s}^{′} ) \} \vert ψ ( 0 ) 〉 \qquad ( S19 )$$

$$= 2 {\int }_{0}^{t} ds {\int }_{0}^{t} {ds}^{′} 〈 ψ ( 0 ) \vert \{ {\hat{g}}_{1} , {U}^{†} ( {s}^{′} ) {\hat{g}}_{j} U ( {s}^{′} ) \} \vert ψ ( 0 ) 〉 \qquad ( S20 )$$

$$= 2 {\int }_{0}^{t} {ds}^{′} 〈 ψ ( 0 ) \vert \{ {\hat{g}}_{1} , {U}^{†} ( {s}^{′} ) {\hat{g}}_{j} U ( {s}^{′} ) \} \vert ψ ( 0 ) 〉 \qquad ( S21 )$$

$$= 2 {\int }_{0}^{t} {ds}^{′} 〈 ψ ( 0 ) \vert \{ {\hat{g}}_{1} ( {s}^{′} ) , {U}^{†} ( {s}^{′} ) {\hat{g}}_{j} U ( {s}^{′} ) \} \vert ψ ( 0 ) 〉 \qquad ( S22 )$$

$$= 4 t {\int }_{0}^{t} {ds}^{′} 〈 ψ ( {s}^{′} ) \vert {\hat{g}}_{1} {\hat{g}}_{j} \vert ψ ( {s}^{′} ) 〉 \qquad ( S23 )$$

$$= t {\int }_{0}^{t} {ds}^{′} 〈 ψ ( {s}^{′} ) \vert {\hat{σ}}_{1}^{z} {\hat{σ}}_{j}^{z} \vert ψ ( {s}^{′} ) 〉 . \qquad ( S24 ) .$$

The third and fifth equalities are from the argument in the proof of Lemma S1 that one may replace ĝ₁(s) with ĝ₁ (and vice versa) when acting on optimal probe states. The penultimate equality is just a consequence of the commutativity of the initial generators.

Apply these general results to specific protocols. Saturating the initial Fisher information conditions in Eq. (S17) implies that one must show

$${\int }_{0}^{t} {ds}^{′} 〈 ψ ( {s}^{′} ) \vert {\hat{σ}}_{1}^{z} {\hat{σ}}_{j}^{z} \vert ψ ( {s}^{′} ) 〉 = \frac{{α}_{j}}{{α}_{1}} t . \qquad ( S25 )$$

Let the gates in our protocols be labeled as Ĝᵢwhere Ĝᵢis either a CNOT or \hat{σ}^{x} gate. The gate Ĝᵢis applied at a time s=tᵢ^{*}. Then, for s∈(tₖ^{*}, tₖ₊₁^{*}), write the time-dependent state as

$$\vert 〈 ψ ( s ) 〉 = \vert ψ ( {τ}^{( k )} ; φ ) 〉 ≡ {\prod }_{i = 0}^{k} {\hat{G}}_{i} \vert ψ ( {τ}^{( 0 )} ; φ ) 〉 , \qquad ( S26 )$$

where |ψ(τ⁽⁰⁾; 0) [symbol] is the initial state of the protocol, φ is the relative phase between the two branches of the state that has accumulated up to time s, and, therefore, |ψ(τ^{(k)}; φ) [symbol] is the state produced after applying the first k gates. Because the protocols explicitly use only \hat{σ}ₓ and CNOT gates to move between families in [symbol] , |ψ(τ^{(k)}; φ) [symbol] =(|0)|χ₀^{(k)} [symbol] +e^{iφ}|1 [symbol] |χᵢ^{(k)} [symbol] )/\sqrt{2}, and

$${\int }_{0}^{t} {ds}^{′} 〈 ψ ( {s}^{′} ) \vert {\hat{σ}}_{1}^{z} {\hat{σ}}_{j}^{z} \vert ψ ( {s}^{′} ) 〉 = {\sum }_{i = 0}^{n} ( {t}_{i + 1}^{*} - {t}_{i}^{*} ) {τ}_{j}^{( i )} \qquad ( S27 )$$

time one is in the probe family |ψ(τ⁽ⁱ⁾; φ) [symbol] , which in the protocols is pᵢt. Thus, to satisfy the Fisher information conditions, one needs

$${\sum }_{i} {p}_{i} {τ}_{j}^{( i )} = \frac{{α}_{j}}{{α}_{1}} ⟹ {( Tp )}_{j} = \frac{{α}_{j}}{{α}_{1}} . \qquad ( S28 )$$

This proves optimality of our time-dependent protocols that satisfy Tp=α/α₁.

### Two Qubit Embodiment.

As derived above, any nonnegative solution (in the sense that pₙ≥0 ∀n) to the system of equations Tp=α/α₁ (Eq. (13)) specifies a valid set of states and evolution times satisfying the saturability condition in Eq. (8). Because the system of equations is under constrained, such protocols do not necessarily use all 3^{d-1} families of states in [symbol] . Here is explicitly consider two qubits. The available states are described by

$$T = ( {τ}^{( 1 )} {τ}^{( 2 )} {τ}^{( 3 )} ) = ( \begin{matrix}1 & 1 & 1 \\ 1 & - 1 & 0\end{matrix} ) . \qquad ( S29 )$$

By Eq. (13), an optimal protocol must satisfy

$${p}_{1} + {p}_{2} + {p}_{3} = 1 \qquad ( S30 )$$

$${p}_{1} - {p}_{2} = \frac{{α}_{2}}{{α}_{1}} . \qquad ( S31 )$$

Solving in terms of p₁ leads to the 1-parameter family of solutions

$${p}_{2} = {p}_{1} - \frac{{α}_{2}}{{α}_{1}} , {p}_{3} = 1 + \frac{{α}_{2}}{{α}_{1}} - 2 {p}_{1} ,$$

and pₙ∈[0,1] for all n. Without loss of generality, assume α₁=1. Then non-negativity is achieved by

$${p}_{1} ∈ \{ \begin{matrix}[ {α}_{2} , \frac{1 + {α}_{2}}{2} ] & {α}_{2} \geq 0 \\ [ 0 , \frac{1 + {α}_{2}}{2} ] & {α}_{2} < 0\end{matrix} . \qquad ( S32 )$$

There are many solutions satisfying these constraints. There is a two-state protocol that does not require using exclusively maximally entangled states: for α₂>0 (α₂<0), let p₁=α₂ (0) so that p₂=0 (−α₂) and p₃=1 α₂ (1+α₂).

### Robust Phase Estimation.

Robust phase estimation protocols extract the quantity of interest q from the state

$$1 / \sqrt{2} ( \vert 0 > + {e}^{iqt / α1} \vert 1 > ) ( \vert 0 … 0 > ) , \qquad ( S33 )$$

which is the final state obtained from the family of optimal protocols.

When the protocols are referred to as optimal, the protocols achieve the conditions on the quantum Fisher information matrix that allow the maximum possible quantum Fisher information with respect to the parameter q to be obtained. However, to completely specify the procedure by which one obtains the quantity q, an explicit phase estimation protocol is specified. Such a task involves that for large times or small α₁=∥α∥∞, it is unclear what 2π interval the relative phase between the branches of Eq. (S33) is in. The phase estimation protocols demonstrate how to optimize resources to deal with this issue, while still saturating the single-shot bound in Eq. (2) up to a small d- and t-independent constant. In particular, such protocols reach a mean square error of

$$ℳ = \frac{{c}^{2} {\vert \vert α \vert \vert}_{∞}^{2}}{{t}^{2}} , \qquad ( S34 )$$

for some small (explicitly known) constant c. Prior work proves that this constant factor c² in Eq. (2) can be reduced to, at best, π².

Putting the final state into the form of Eq. (S33) reduces this problem to the single qubit, multipass version of the problem.

Consider dividing the total time t, which is the relevant resource in the problem, into K stages where is evolved for a time Mⱼδt in the j-th stage (δt is some small basic unit of time and Mⱼ∈ [symbol] ). Assume that there is (d,t)-independent, prior knowledge of q such that one can set ot to satisfy

$$\frac{δ tq}{{\vert \vert α \vert \vert}_{∞}} ∈ [ 0 , 2 π . ) \qquad ( S35 )$$

In the j-th stage, using one of the protocols for a time Mⱼδt, prepare 2vⱼ independent copies of the state

$$\vert {ψ}_{j} 〉 = \frac{1}{\sqrt{2}} ( \vert 0 〉 + {e}^{iqMj δ t / \vert \vert α \vert \vert ∞} \vert 1 〉 ) \vert 0 … 0 〉 , \qquad ( S36 )$$

From now on, drop the d−1 qubit sensors in the state |0 . . . 0>, as they are irrelevant; however, it is worth noting that it is not necessary to put the state in this form before performing measurements. Then perform a single-qubit measurement on the first qubit sensor of each of these state copies, yielding 2vⱼ measurement outcomes, which one can use to estimate q. The total time of this K stage protocol is consequently given by

$$t = 2 {\sum }_{j = 1}^{K} {v}_{j} {M}_{j} δt . \qquad ( S37 )$$

Given this setup, choose single-qubit measurements and optimize the choice of vⱼ, Mⱼ per stage so that one can learn q bit by bit, stage by stage, in such a way that optimal scaling in d, t is still obtained (Eq. (S34)). In particular, consider making two measurements, each vⱼ times per stage (thus explaining the factor of two introduced earlier): (i) a \hat{σ}^{x} measurement and (ii) a \hat{σ}^{y} measurement. These measurements each give outcomes that are Bernoulli variables (i.e., with values ∈{0,1}) with outcome probabilities

$$\begin{matrix}{p}^{( x )} ( 0 ) = \frac{1 + cos ( {M}_{j} q δ t / {\vert \vert α \vert \vert}_{∞} )}{2} \\ {p}^{( x )} ( 1 ) = 1 - {p}^{( x )} ( 0 ) , \\ {p}^{( y )} ( 0 ) = \frac{1 + sin ( {M}_{j} q δ t / {\vert \vert α \vert \vert}_{∞} )}{2} , \\ {p}^{( y )} ( 1 ) = 1 - {p}^{( y )} ( 0 ) ,\end{matrix} \qquad ( S38 )$$

where the first two probabilities are for the \hat{σ}ₓ measurement, and the latter two are for the \hat{σ}^{y} measurement. Using both of these measurements allows one to resolve the two-fold degeneracy in the phase qMⱼδt/∥α∥∞ within a given [0,2π) interval that would arise from, e.g., a \hat{σ}ₓ measurement alone. The observed probabilities of obtaining 0 for the \hat{σ}ₓ and \hat{σ}_{y} are independent random variables that converge in probability to their associated expectation values for vⱼ→∞. These measurements are non-adaptive, which makes this particular phase estimation protocol especially appealing.

At each stage, extract an estimator \tilde{ϕ} of ϕ:=Mⱼqδt/∥α∥∞ as

$$\tilde{ϕ} := atan 2 ( 2 {f}_{0}^{( y )} - 1 , 2 {f}_{0}^{( x )} - 1 ) ∈ [ 0 , 2 π ) , \qquad ( S39 )$$

where atan2 is the 2-argument arctangent with range [0,2π). In the limit vⱼ→∞, this estimator indeed converges to ϕ, but an advantage of this phase estimation scheme lies in the correct reprocessing of data stage-by-stage so that vⱼ can be kept (d,t)-independent. Picking Mⱼ=2^{j-1} for j∈{1, . . . ,K} and optimizing over vⱼ one can, at each stage, estimate q/∥α∥∞ with a confidence interval of size 2π/(3×2^{j-1}) so that in each stage learn another bit of this quantity. The results of this optimization are vⱼ that decrease linearly with the step j so that as the time spent in a stage grows, the statistics we employ shrink. It happens that one can scale K→∞ (i.e., take an asymptotic in t limit) while maintaining v_{K} constant. The net result is a mean square error given by Eq. (S34) with c =24.26π, which is a factor of 24.26 greater than the theoretical optimal value, but with the convenient feature that the protocol uses non-adaptive measurements.

Other protocols are possible. For instance, in prior work, a similar two-step method is described for the estimation of global parameters (i.e., where the parameter is not restricted to a local neighborhood of parameter space). This protocol provides an explicit method to use some (ultimately negligible) fraction of the sensing time available to narrow down the location of the parameter q in parameter space, followed by an optimal local estimation. The explicit estimation scheme herein does not require adaptive measurements.

### Proof of Theorem 1.

Theorem 1. Let q(θ)=α·θ. Without loss of generality, let ∥α∥∞=|α₁|. Let k∈ [symbol] ⁺ so that

$$k - 1 < \frac{{\vert \vert α \vert \vert}_{1}}{{\vert \vert α \vert \vert}_{∞}} \leq k . \qquad ( S40 )$$

An optimal protocol to estimate q(θ), where the parameters θ are encoded into the probe state via unitary evolution under the Hamiltonian in Eq. (1), involves at least, but no more than, k-partite entanglement.

Proof. The proof is divided in two parts. In Part 1, using k-partite entangled states from the set of cat-like states considered, the existence of an optimal protocol is shown, subject to the upper bound of Eq. (S40). Part 2 shows that there exists no optimal protocol using at most (k−1)-partite entanglement, proving the lower bound of Eq. (S40).

Part 1. Define T^{(k)} as the submatrix of T with all columns n such that Σₘ|Tₘₙ|>k are eliminated, which enforces that any protocol derived from T^{(k)}uses only states that are at most k-partite entangled. Define System A(k) as

$${T}^{( k )} {p}^{( k )} = α / α1 , \qquad ( S41 )$$

$${p}^{( k )} \geq 0. \qquad ( S42 )$$

Let α′=α/α₁ and define System B(k) as

$${( {T}^{( k )} )}^{T} y \geq 0 \qquad ( S43 )$$

$$< {α}^{′} , y > < 0 \qquad ( S44 )$$

By the Farkas-Minkowski lemma, System A(k) has a solution if and only if System B(k) does not. In particular, this lemma, which, geometrically, is an application of the hyperplane separation theorem is as follows:

Lemma S2 (Farkas-Minkowski). Consider the system

$$Ax = b , \qquad ( S45 )$$

$$x \geq 0 , \qquad ( S46 )$$

with A∈ [symbol] ^{m×n}, x∈ [symbol] ⁿ, and b∈ [symbol] ^{m}. The above system has a solution if and only if there is no solution y to

$${A}^{T} y \geq 0 , \qquad ( S47 )$$

$$< b , y > < 0. \qquad ( S48 )$$

Therefore, to prove the result it is sufficient to show that System B(k) does not have a solution if Σ_{j>1}|αⱼ′|≤k−1, where α′₁=1. Assume that a solution y exists and arrive at a contradiction. Without loss of generality, assume that |yᵢ|≥|yⱼ₊₁| for all 1<j<d. Eq. (S44) implies Σ_{j>1}αⱼ′yⱼ<−y₁. (T^{(k)})^{T} has a row n* given by τ⁽ⁿ⁺⁾=(1,0, . . . ,0), so by Eq. (S43) any solution y to System B has y₁≥0. Therefore, |Σ_{j>1}αⱼ′yⱼ|>y₁, which, by the triangle inequality, implies

$${\sum }_{j > 1} \vert {{α}_{j}}^{′} \vert \vert {y}_{j} \vert > {y}_{1} . \qquad ( S49 )$$

Because |αⱼ′|≤1 for all j, because Σ_{j>1}|αⱼ′|≤k−1, and because |yⱼ| for j>1 are ordered in descending order, the largest the left-hand-side of Eq. (S49) can be is Σⱼ₌₂^{k}|yⱼ|, leading to

$${\sum }_{j = 2}^{k} \vert {y}_{j} \vert > {y}_{1} . \qquad ( S50 )$$

This directly contradicts Eq. (S43) for the row of T^{(k)} given by τ=(1,−sgn(y₂), . . . , −sgn(yₖ),0,0, . . . ).

Part 2. Using Eq. (S24), for any optimal protocol,

$${ℱ ( θ )}_{1 j} = t {\int }_{0}^{t} {ds}^{′} 〈 ψ ( {s}^{′} ) \vert {\hat{σ}}_{1}^{z} {\hat{σ}}_{j}^{z} \vert ψ ( {s}^{′} ) 〉 , \qquad ( S51 )$$

where recall |Ψ(s)>=Û(s)|Ψ(0)>. Because [symbol] ψ(s′)|\hat{τ}₁^{z}|ψ(s′) [symbol] =0 for all s′ (see Eq. (S16)), the integrand is non-zero if and only if |Ψ(s′)> is such that the first qubit is entangled with the jth. Define the indicator variable

$${E}_{j} ( {s}^{′} ) = \{ \begin{matrix}1 & \vert ψ ( s ) > entangles qubit j and 1 \\ 0 & else\end{matrix} \qquad ( S52 )$$

for all j, including any possible ancilla qubits. Here, define E₁=1 even though the first qubit is not entangled with itself. Further define

$$E ( {s}^{′} ) = {Σ}_{j} {E}_{j} ( {s}^{′} ) \leq ( k - 1 ) , \qquad ( S53 )$$

where E(s′) is the total number of sensor qubits entangled with the first qubit at time s′, and the upper bound comes from the assumption on the partite-ness of the probe states. Then,

$${ℱ ( θ )}_{1 j} \leq t {\int }_{0}^{t} {ds}^{′} {E}_{j} ( {s}^{′} ) . \qquad ( S54 )$$

Furthermore, for any optimal protocol using at most (k−1)-partite entanglement, require that

$${\sum }_{j} \vert \frac{{α}_{j}}{{α}_{1}} {t}^{2} \vert = {\sum }_{j} \vert {ℱ ( θ )}_{j 1} \vert \leq t {\sum }_{j} {\int }_{0}^{t} {ds}^{′} {E}_{j} ( {s}^{′} ) = t {\int }_{0}^{t} {ds}^{′} {\sum }_{j} {E}_{j} ( s ) \leq t {\int }_{0}^{t} {ds}^{′} ( k - 1 ) = ( k - 1 ) {t}^{2} . \qquad ( S55 )$$

This is a contradiction, however, as the theorem statement assumed that

$${\sum }_{j} \vert \frac{{α}_{j}}{{α}_{1}} {t}^{2} \vert = \frac{{‖ α ‖}_{1}}{{‖ α ‖}_{∞}} {t}^{2} > ( k - 1 ) {t}^{2} . \qquad ( S56 )$$

This concludes the proof that (k−1)-partite entanglement in any form (i.e., not just from cat-like probe states) is insufficient to generate an optimal protocol. □

The lower bound on the size of the least entangled state used in an optimal protocol is a lower bound on the average entanglement required to saturate the Fisher Information matrix conditions. Here, average entanglement refers to weighting the size of the entangled state by the proportion of time it is used in the protocol. This lower bound is simply ∥α∥₁/∥α∥∞. The lower bound on the size of the most-entangled state, or the bound on instantaneous entanglement, comes from ensuring that this lower bound on average entanglement is achievable (i.e., if the instantaneous entanglement is too small at each stage, then the average entanglement required cannot be reached).

### Non-Echoed Protocols.

A subset of protocols, referred to as non-echoed, possess some beneficial features.

Definition S2 (Non-Echoed Protocols). Consider some α∈ [symbol] ^{d} encoding a linear function of interest. Let T be the matrix which describes the families of cat-like probe states described above, and let p specify a valid protocol such that p>0 and Tp=α/∥α∥∞. The protocol defined by p is non-echoed if ∀i such that pᵢ is strictly greater than 0, sgn(Tᵢⱼ)∈{0,sgn(αⱼ)}.

At any stage of a non-echoed protocol, letting the portion of the relative phase accumulated between the two branches of the probe state associated to the parameter θᵢ be given by cᵢθᵢ, two conditions must hold: (1) |cᵢ|<|αᵢ|; (2) sgn(cᵢ)=sgn(αᵢ). More intuitively, sensitivity to each parameter is accumulated “in the correct direction” at all times, such that one does not use any sort of spin echo to produce a sensitivity to the function of interest, hence the name non-echoed.

Lemma S3. Non-echoed protocols use minimum average entanglement.

Proof. Let Tp=α/∥α∥∞. Without loss of generality, assume that one has restricted p to its non-zero support and similarly deleted the columns of T that correspond to the zero support of p such that all remaining columns are actually used in the protocol for nonzero amount of time. Then

$${‖ α ‖}_{1} / {‖ α ‖}_{∞} = sgn {( α )}^{T} ( T p ) = ( sgn {( α )}^{T} T ) p = {w}^{T} p , \qquad ( S57 )$$

where wⱼ=Σᵢ|Tᵢⱼ| is the sum of the absolute value of the elements of the jth column of T. That is, wⱼ represents how entangled the corresponding cat-like family of states is. But, then, clearly w^{T}p is the average entanglement of the entire protocol. Furthermore, the second half of the proof of Theorem 1 shows that the minimum average entanglement of any optimal protocol is given by ∥α∥₁/∥α∥∞ (as argued after the completion of the proof). □

The intuition behind this lemma is that if one always accumulates phase in the “correct direction,” then the total amount of entanglement used over the course of the protocol must be minimized, as any extra entanglement would lead to becoming overly sensitive to some parameter, which would involve some sort of echo in the protocol to correct.

Lemma S4. For any function encoding α, there exists a non-echoed protocol with minimum instantaneous entanglement.

Proof. Assume without loss of generality that α₁=∥α∥∞=1. Also assume, for computational simplicity, that α_{i>1}<1 (i.e., there is only a single maximal-magnitude element of α) and that αᵢ>0∀i. These latter assumptions can easily be lifted, as described at the end of the proof.

Use the Farkas-Minkowski lemma to show that no vector y exists such that

$${( {T}_{+}^{( k )} )}^{T} y \geq 0 \qquad ( S58 )$$

$$< α , y > < 0 , \qquad ( S59 )$$

proving the existence of a non-echoed protocol. Here, T₊^{(k)} is T restricted to non-echoed vectors (i.e., (T₊^{(k)})ᵢⱼ^{T}∈{0,1}) with weight at most k, where k=┌∥α∥₁┐. Assume a solution y exists. Noting that (T₊^{(k)})^{T} has a row given by (1,0, . . . ,0), it must be that y₁≥0. Further, for y to be a valid solution, we must have

$$〈 α , y 〉 = {α}_{1} {y}_{1} + {\sum }_{i \vert i \neq 1 , {y}_{i} \geq 0} {α}_{i} {y}_{i} + {\sum }_{i \vert {y}_{i} < 0} {α}_{i} {y}_{i} = {y}_{1} + {\sum }_{i \vert i \neq 1 , {y}_{i} \geq 0} {α}_{i} {y}_{i} + {\sum }_{i \vert {y}_{i} < 0} {α}_{i} {y}_{i} \leq 0. \qquad ( S60 )$$

Proceed with two cases. Suppose that at most k−1 elements of y are negative. Consider the row of (T₊^{(k)})^{T} that has a 1 in the first index and exactly on the indices where yᵢ<0 (which exists because we have sufficiently restricted the number of negative elements of y). Then (T₊^{(k)})^{T}y≥0 implies that

$${y}_{1} + {\sum }_{i \vert {y}_{i \leq 0}} {y}_{i} \geq 0. \qquad ( S61 )$$

But because αᵢ<1, this immediately implies that

$${y}_{1} + {\sum }_{i \vert {y}_{i \leq 0}} {α}_{i} {y}_{i} \geq 0 , \qquad ( S62 )$$

which means that Eq. (S60) cannot be true, yielding a contradiction.

Now suppose that there are at least k elements of y that are negative. Let S be the set of indices corresponding to the k−1 largest, in magnitude, yᵢ. Then the row of (T₊^{(k)})^{T} with a 1 in the first index and precisely on the indices in S leads to the condition that

$${y}_{1} + {\sum }_{i ∈ S} {y}_{i} \geq 0. \qquad ( S63 )$$

However, given the constraint that α_{i>1}<1,

$${y}_{1} + {\sum }_{i \vert i \neq 1 , {y}_{i} \geq 0} {α}_{i} {y}_{i} + {\sum }_{i \vert {y}_{i} < 0} {α}_{i} {y}_{i} \geq {y}_{1} + {\sum }_{i ∈ S} {y}_{i} \geq 0 , \qquad ( S64 )$$

which is a contradiction.

With regard to lifting the two assumptions mentioned earlier, in the case where there exists multiple maximal elements, the same argument that generalizes the main theorem will generalize this argument. If αᵢ<0, a protocol still exists; simply replace (T₊^{(k)})ᵢⱼ=1 with sgn(ai) (and leave 0s untouched).

□

Together, these lemmas prove that there exist protocols that can minimize both instantaneous entanglement (i.e., the maximum size of a cat-like state used in the protocol) and the average entanglement over the course of the entire protocol.

### CNOT Costs of Minimal Entanglement Protocols.

Another resource of potential interest is the number of entangling (CNOT) gates required to perform the protocols with a focus on the minimum entanglement protocols.

Assume ∥α∥∞=α₁=1>|α₂|≥|α₃|≥. . . ≥|α_{d}|. Furthermore, without loss of generality, adopt the convention that an optimal protocol specified by a p≥0 such that Tp=α begins by preparing the state described by the first column of T and evolving for time p₁t, and then proceeds to the appropriate state (i.e., the one with phase p₁t) in the family described by the second column, then evolving for time p₂t, and so on, until eventually moving to the measurement state. If pᵢ=0, the corresponding state is skipped and not prepared. By construction, the number of CNOT gates needed to perform this protocol is the number of gates required to generate the first state, plus the number needed to convert from the first state to the second state, and so on. Finally, one should add the number of gates needed to prepare the measurement state, which disentangles all qubits, from the final probe state. The number of gates required to move from state i to state i+1 corresponds to the number of indices of τᵢ that are +1 but 0 in τᵢ₊₁ and vice versa. In what follows, consider only the gates that are used to convert between probe states (i.e., do not consider the initial state preparation or final measurement preparation). This is physically motivated by the fact that these intermediate gates may be more difficult to perform or may be more susceptible to noise. Additionally, the main resource in which our protocols attempt to achieve Heisenberg scaling is the time that our probe states are coupled to the parameters of interest. Therefore, assuming one is interested in the value of these parameters at some given moment (and not, say, continuously), one might be free to prepare and purify the initial probe state in advance of the actual sensing task, which also justifies ignoring the initial CNOT cost.

Assume that N̅ states used in the protocol, i.e. p is such that it contains at most N̅ nonzero elements. It is clear that at most O(N̅ ²) CNOT gates are needed. However, this is not necessarily optimal. U.S. Pat. 10,007,885, which is incorporated by reference herein in its entirety, provides a protocol that uses d states and only (d−1)=O(d) intermediate CNOT gates. This disentangling protocol includes using a maximally entangled (GHZ) state for a time |α_{d}|t, then disentangling the last qubit and using the (d−1)-entangled state for time (|α_{d-1}|−|α_{d}|)t before disentangling the next-to-last qubit and so on until reaching the final state corresponding to τ=(1,0, . . . , 0)^{T}. This final state is used for time (|α₁|−|α₂|)t=(1−|α₂|)t. The disentangling protocol does not minimize the instantaneous entanglement, but it does minimize average entanglement (as it is a non-echoed protocol).

U.S. Pat. 10,007,885, which is incorporated by reference herein in its entirety, provides the echoing protocol that uses zero intermediate CNOT gates. It proceeds by using d exclusively maximally entangled states. Thereby, minimizing neither average nor instantaneous entanglement, but echoing away the extra sensitivity that this extra entanglement induces.

To illustrate these protocols, T and p (wherein T and p is restricted to the states that are used for a non-zero fraction of time) for the case d=8 and αᵢ>0:

$${T}^{disentangling} = ( \begin{matrix}1 & 1 & 1 & 1 & 1 & 1 & 1 & 1 \\ 1 & 1 & 1 & 1 & 1 & 1 & 1 & 0 \\ 1 & 1 & 1 & 1 & 1 & 1 & 0 & 0 \\ 1 & 1 & 1 & 1 & 1 & 0 & 0 & 0 \\ 1 & 1 & 1 & 1 & 0 & 0 & 0 & 0 \\ 1 & 1 & 1 & 0 & 0 & 0 & 0 & 0 \\ 1 & 1 & 0 & 0 & 0 & 0 & 0 & 0\end{matrix} ) , {p}^{disentangling} = ( \begin{matrix}{α}_{s} \\ {α}_{7} - {α}_{8} \\ {α}_{6} - {α}_{7} \\ {α}_{5} - {α}_{6} \\ {α}_{4} - {α}_{5} \\ {α}_{3} - {α}_{4} \\ {α}_{2} - {α}_{3}\end{matrix} ) \qquad S65 )$$

$$and$$

$${T}^{echoing} = ( \begin{matrix}1 & 1 & 1 & 1 & 1 & 1 & 1 & 1 \\ 1 & 1 & 1 & 1 & 1 & 1 & 1 & - 1 \\ 1 & 1 & 1 & 1 & 1 & 1 & - 1 & - 1 \\ 1 & 1 & 1 & 1 & 1 & - 1 & - 1 & - 1 \\ 1 & 1 & 1 & 1 & - 1 & - 1 & - 1 & - 1 \\ 1 & 1 & 1 & - 1 & - 1 & - 1 & - 1 & - 1 \\ 1 & 1 & - 1 & - 1 & - 1 & - 1 & - 1 & - 1 \\ 1 & - 1 & - 1 & - 1 & - 1 & - 1 & - 1 & - 1\end{matrix} ) , \qquad ( S66 )$$

$${p}^{echoing} = ( \begin{matrix}\frac{1 + {α}_{s}}{2} \\ \frac{{α}_{7} - {α}_{8}}{2} \\ \frac{{α}_{6} - {α}_{7}}{2} \\ \frac{{α}_{5} - {α}_{6}}{2} \\ \frac{{α}_{4} - {α}_{5}}{2} \\ \frac{{α}_{3} - {α}_{4}}{2} \\ \frac{{α}_{2} - {α}_{3}}{2} \\ \frac{{α}_{1} - {α}_{2}}{2}\end{matrix} ) .$$

In the case of the disentangling protocol, the number of CNOTs involved depends on the ordering of the states. For example, consider instead ordering the states in the following way:

$${T}^{disentangling} = ( \begin{matrix}1 & 1 & 1 & 1 & 1 & 1 & 1 & 1 \\ 1 & 0 & 1 & 1 & 1 & 1 & 1 & 1 \\ 1 & 0 & 1 & 0 & 1 & 0 & 1 & 1 \\ 1 & 0 & 1 & 0 & 1 & 0 & 1 & 1 \\ 1 & 0 & 1 & 0 & 1 & 0 & 1 & 0 \\ 1 & 0 & 1 & 0 & 1 & 0 & 0 & 0 \\ 1 & 0 & 1 & 0 & 0 & 0 & 0 & 0 \\ 1 & 0 & 0 & 0 & 0 & 0 & 0 & 0\end{matrix} ) . \qquad ( S67 )$$

Here, the number of CNOTs involved is now (d−1)+(d−2)+. . . +1=Θ(d²). Thus, it is not only the choice of states that affects the CNOT cost of a protocol but also their ordering. Naively, finding an optimal set of states and their optimal ordering is a difficult problem, as if one finds a protocol using N̅ states, there are N̅! orders to check.

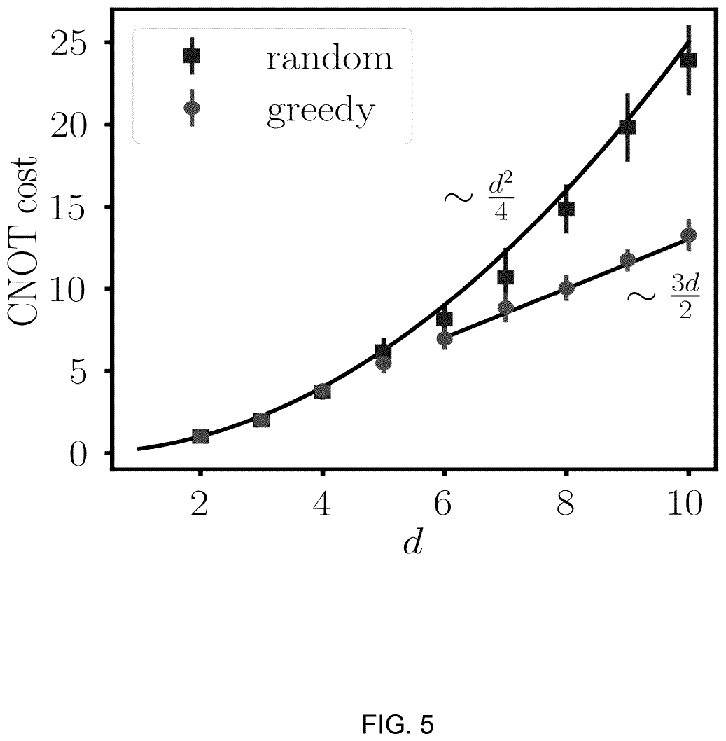

While not finding a general solution to this optimization problem, numerics provide a pragmatic analysis of the cost. To begin, consider the naive approach of finding a random (non-echoed) minimum entanglement solution using d states for random problem instances and, then, using this solution set, brute-force search over all column orderings of this solution to find an optimal ordering in terms of CNOT cost. This was done for d∈[3,10] sensors with twenty random instances each. Without loss of generality, the random problem instances were taken to have all positive coefficients. Observe a CNOT cost scaling ˜d², indicating that a random minimum entanglement solution, even with optimal ordering, does not have the linear in d scaling we would like. See FIG. 5.

Other algorithms for finding a minimum entanglement solution with better CNOT costs may be desirable. To this end, a greedy algorithm yields a Θ(d) CNOT cost whenever it does not fail. The algorithm works by building up the full sensitivity to one parameter before switching coherently to a new state family (in this way, it is non-echoed). Consequently, each time one switches to a new state, one sensor qubit can be disentangled and never reentangled. In particular, one builds sensitivity to the parameters according to their weight in q, i.e., one builds sensitivity to parameters going from the smallest corresponding |αⱼ| to the largest. The full algorithm is completed in at most d steps.

The greedy algorithm can fail to produce a valid protocol, as it does not enforce the condition that ∥p∥₁=1. This condition can be violated for some functions, e.g., those with many coefficients with approximately equal magnitude. When it works, this algorithm succeeds in producing CNOT-efficient minimum entanglement protocols, as shown in FIG. 5.

Independent of the algorithm used to minimize the CNOT count of an optimal protocol, there is a tradeoff between entanglement- and gate-based resources. The disentangling protocol minimizes average entanglement, but not necessarily instantaneous entanglement, and requires only O(d) intermediate entangling gates; the echoing protocol uses maximal entanglement and requires only single-particle intermediate gates. Protocols that minimize instantaneous entanglement do so at the cost of more intermediate entangling gates. Depending on the primary sources of error or the physical constraints on any given quantum sensor network implementation, one of these resources might be more important to minimize than the other.

If decoherence is more problematic than the number of entangling gates that one must perform, then minimum entanglement protocols will be preferred to the conventional protocols. Even in the case that intermediate entangling gates present more difficulties than decoherence, the protocol is useful from the perspective of understanding and appreciating the resource tradeoffs inherent to these metrological problems, as it is likely that any experimental implementation will require balancing entangling gate errors and decoherence.

Another resource-related constraint of protocols that relies on time-dependent control (whether in the form of \hat{σ}^{x} gates, CNOT gates, or others) includes protocols that involve precise timing of the gate applications. Uncertainty in the timing leads directly to an error in the function being measured. The timing issue is a limitation of known optimal protocols for the linear function estimation.

### Probabilistic Protocols Fail to Achieve Saturability Condition.

Time-independent probabilistic protocols fail to achieve the saturability condition of Eq. (8). That is, when resources are properly accounted for, it is impossible to achieve a Fisher information matrix satisfying

$${ℱ ( θ )}_{1 j} = \frac{{α}_{j}}{{α}_{1}} {t}^{2} \qquad ( S68 )$$

for generic linear functions. Again, restrict consideration to a single maximal magnitude αⱼ. The proof follows almost identically, with some notational overhead, when generalizing beyond this condition.

In particular, to fairly account for resources, fix a total time t to perform all stages of our protocol. Therefore, when considering a probabilistic protocol using multiple families from [symbol] , assign a time tⱼ for each state |Ψ(τⱼ;0)> (because this does not switch between probe states using a control Hamiltonian, one does not consider an arbitrary phase) used in the protocol such that

$${\sum }_{n = 1}^{\overline{N}} {t}_{n} = t , \qquad ( S69 )$$

where N̅ is the number of families in [symbol] that are used a non-zero fraction of the time in a given protocol. That is, for a given solution to Tp=α/α₁, N̅ denotes the number of non-zero pₙ. No stages of a probabilistic protocol with the families in [symbol] can be performed simultaneously. One could imagine protocols that parallelize the measurement of some qⱼ that involve disjoint sets of sensors. However, such protocols are necessarily non-optimal given Lemma S1, such that any optimal protocol requires entanglement with the first qubit at all times.

One can bound the maximum of the Fisher information matrix element [symbol] (θ)₁₁ obtainable via such a probabilistic protocol as

$$max {ℱ ( θ )}_{11} \leq {max}_{{p}_{n} , {t}_{n}} {\sum }_{n = 1}^{\overline{N}} {p}_{n} {t}_{n}^{2} , \qquad ( S70 )$$

$$subject to : {\sum }_{n = 1}^{\overline{N}} {t}_{n} = t ,$$

$${\sum }_{n = 1}^{\overline{N}} {p}_{n} = 1$$

where [symbol] ₗ⁽ⁿ⁾=1 for all n. The inequality arises due to the fact that the maximization problem on the right hand side of the inequality does not enforce that Tp=α/α₁. This is not a necessary additional constraint.

Solving this optimization problem via Lagrange multipliers is straightforward. The Lagrangian is

$$ℒ = {\sum }_{n = 1}^{\overline{N}} {p}_{n} {t}_{n}^{2} + {γ}_{1} ( t - {\sum }_{n = 1}^{\overline{N}} {t}_{n} ) + {γ}_{2} ( 1 - {\sum }_{n = 1}^{\overline{N}} {p}_{n} ) , \qquad ( S71 )$$

where γ₁, γ₂ are Lagrange multipliers. Therefore, the system of equations includes

$$2 {p}_{n} {t}_{n} - {γ}_{1} = 0 , ( ∀ n ) \qquad ( S72 )$$

$${t}_{n}^{2} - {γ}_{2} = 0 , ( ∀ n ) ,$$

$${\sum }_{n = 1}^{\overline{N}} {t}_{n} = t ,$$

$${\sum }_{n = 1}^{\overline{N}} {p}_{n} = 1 ,$$

which can is solved to yield the solution

$${max}_{{p}_{n} , {t}_{n}} {\sum }_{n = 1}^{\overline{N}} {p}_{n} {t}_{n}^{2} = \frac{{t}^{2}}{{\overline{N}}^{2}} \qquad ( S73 )$$

for pₙ=1/N̅ and tₙ=t/N̅ for all n. Therefore,

$${ℱ ( θ )}_{1 j} \leq \frac{{t}^{2}}{{\overline{N}}^{2}} , ( ∀ j ) , \qquad ( S74 )$$

which fails to achieve the saturability condition for j=1, unless N̅=1, which is only possible for a very small set of functions. For generic functions N̅ scales nontrivially with d. Therefore, provided one considers cases where each qⱼ must be learned sequentially (which is a requirement for any optimal protocol via Lemma S1), saturability is not obtained even up to a d-independent constant for generic functions via time-independent protocols.

### Relaxing the Assumption on a Single Maximum Element.

To generalize beyond the assumption that |α₁|>|αⱼ| for all j>1, the algebra varies. Generalizing Eq. (8), let

$$L := \{ i \vert \vert {α}_{i} \vert = \vert {α}_{1} \vert \} . \qquad ( S75 )$$

The assumption |α₁|>|αⱼ| for all j>1 is equivalent to assuming |L|=1. For arbitrary size L, conditions for the single-parameter bound on q(θ) to be saturable (Eqs. (6) and (7)) are:

$${ℱ ( q )}_{11} = \frac{{t}^{2}}{{α}_{1}^{2}} , \qquad ( S76 )$$

$${ℱ ( q )}_{1 i} = {ℱ ( q )}_{i 1} = 0 ( ∀ i \neq 1 ) . \qquad ( S77 )$$

Recall that [symbol] (q)=J^{T} [symbol] (θ)J, where J is the Jacobian for the basis transformation from θ to q, q₁=q is the linear function to measure, and the other qⱼ are some other degrees of freedom we fix. Show that Eqs. (S76)-(S77) are satisfied if and only if

$${\sum }_{i ∈ L} \frac{sgn ( {α}_{1} )}{sgn ( {α}_{i} )} {ℱ ( θ )}_{ji} {λ}_{i} = \frac{{α}_{j}}{{α}_{1}} {t}^{2} , \qquad ( S78 )$$

where λᵢ≥0 such that Σᵢλᵢ=1. If |L|=1, this reduces to Eq. (8).
Recounting how to obtain the single-parameter bound to saturate, referring to Eq. (3), a choice of basis that minimizes ∥ĝ_{q}∥ [symbol] ², yields the tightest possible bound on [symbol] , the mean-square error of q. Our basis for [symbol] ^{d} is {α⁽¹⁾, α⁽²⁾, . . . , α^{(d)}}, where α⁽¹⁾=α. Now, J⁻¹ has rows given by these vectors. Let {β⁽¹⁾, β⁽²⁾, . . . , β^{(d)}} be the basis dual to this one. That is, these vectors form the columns of J and satisfy α⁽ⁱ⁾·β^{(j)}=δᵢⱼ such that

$${θ}^{T} = {( J J - 1 θ )}^{T} = {( {J}^{- 1} θ )}^{T} {J}^{T} , \qquad ( S79 )$$

### and the Hamiltonian is

$$\hat{H} = \frac{1}{2} {θ}^{T} \hat{σ} + {\hat{H}}_{c} ( s ) = \frac{1}{2} {\sum }_{i = 1}^{d} ( {α}^{( i )} \cdot θ ) {β}^{( i )} \cdot \hat{σ} + {\hat{H}}_{c} ( s ) , \qquad ( S80 )$$

where \hat{σ}=(\hat{σ}ₗ^{z}, . . . , \hat{σ}_{d}^{z})^{T}. Then

$${\hat{g}}_{q} ( 0 ) = \frac{\partial \hat{H}}{\partial q} = \frac{\partial \hat{H}}{\partial ( {α}^{( 1 )} \cdot θ )} = \frac{β \cdot \hat{σ}}{2} , \qquad ( S81 )$$

where β=β⁽¹⁾. Because the seminorm is time-independent, such that

$${‖ {\hat{g}}_{q} ‖}_{s} = {‖ β ‖}_{1} , \qquad ( S82 )$$

and the tightest bound is

$${min}_{β} {‖ β ‖}_{1} , s . t . α \cdot β = 1. \qquad ( S83 )$$

$$with$$

$$1 = {\sum }_{i} {α}_{i} {β}_{i} \leq {\sum }_{i} \vert {α}_{i} \vert \vert {β}_{i} \vert \leq \vert {α}_{1} \vert {\sum }_{i} \vert {β}_{i} \vert = \vert {α}_{1} \vert {‖ β ‖}_{1} . \qquad ( S84 )$$

The first inequality is tight if either sgn(βᵢ)=sgn(αᵢ) or βᵢ=0 for all i. The second is slightly more complicated to saturate. Recall L={i∥αᵢ|=|α₁|}. Then the second inequality is tight if and only if

$${β}_{i} = 0 for i \neq L , \qquad ( S85 )$$

$${\sum }_{i ∈ L} \vert {β}_{i} \vert = \frac{1}{\vert {α}_{1} \vert} . \qquad ( S86 )$$

Any solution β specifies the first column of the Jacobian J so that the conditions in Eq. (S76)-(S77) are

$${ℱ ( q )}_{11} = {β}^{T} ℱ ( θ ) β = \frac{{t}^{2}}{{α}_{1}^{2}} , \qquad ( S87 )$$

$${ℱ ( q )}_{1 i} = {ℱ ( q )}_{i 1} = {( {β}^{( i )} )}^{T} ℱ ( θ ) β = 0 ( ∀ i \neq 1 ) . \qquad ( S88 )$$

As α⁽ⁱ⁾·β^{(j)}=δᵢⱼ, Eq. (S88) implies, vector [symbol] (θ)β is proportional to α, and Eq. (S87) specifies the constant of proportionality. In particular,

$$ℱ ( θ ) β = \frac{{t}^{2}}{{α}_{1}^{2}} α . \qquad ( S89 )$$

Invoking Eqs. (S85)-(S86) and the condition that sgn(βᵢ)=sgn(αᵢ) for βᵢ≠0, βᵢ=λᵢsgn(αᵢ)/|α₁|, where λᵢ≥0 for i∈L and λᵢ=0 for i≠L such that Σᵢλᵢ=1. The individual components of Eq. (S89) imply

$${\sum }_{i ∈ L} {ℱ ( θ )}_{ij} sgn ( {α}_{i} ) {λ}_{i} = {\sum }_{i ∈ L} {ℱ ( θ )}_{ji} sgn ( {α}_{i} ) {λ}_{i} = \frac{{t}^{2}}{\vert {α}_{1} \vert} {α}_{j} , {\sum }_{i} {λ}_{i} = 1 , {λ}_{i} \geq 0 , \qquad ( S90 )$$

which, using |α₁|=sgn(α₁)α₁ and that sgn(α₁)sgn(αᵢ)=sgn(α₁)/sgn(αᵢ) for i∈L, yields

$${\sum }_{i ∈ L} \frac{sgn ( {α}_{1} )}{sgn ( {α}_{i} )} {ℱ ( θ )}_{ij} {λ}_{i} = {\sum }_{i ∈ L} \frac{sgn ( {α}_{1} )}{sgn ( {α}_{i} )} {ℱ ( θ )}_{ji} {λ}_{i} = \frac{{α}_{j}}{{α}_{1}} {t}^{2} , {\sum }_{i} {λ}_{i} = 1 , {λ}_{i} \geq 0 , \qquad ( S91 )$$

which reduces to Eq. (8) of the main text, when |L|=1, as desired.

One can generalize the derivation of Eq. (13) to this setting of more than one maximum element of α. In particular, Lemma S1 is extended to Lemma S5.

Lemma S5. Any optimal protocol, independent of the choice of control, requires that < [symbol] (t)>=0 for all j∈L and that the probe state be of the form

$$\vert ψ 〉 = \frac{( {⊗}_{j ∈ L} \vert {b}_{j} 〉 ) \vert {φ}_{0} 〉 + {e}^{i ϕ} ( {⊗}_{j ∈ L} \vert {b}_{j} + 1 〉 ) \vert {φ}_{1} 〉}{\sqrt{2}} , \qquad ( S92 )$$

for all times s∈[0,t], where

$${b}_{j} = \{ \begin{matrix}0 , & if sgn ( {α}_{j} ) = 1 , \\ 1 , & if sgn ( {α}_{j} ) = - 1 ,\end{matrix} \qquad ( S93 )$$

and ϕ, |φ₀>, |φ₁> can be arbitrary and s-dependent. The addition inside the second ket of Eq. (S92) is mod 2.

Proof. Fact (1): Σ_{i∈L}λᵢ(sgn(αᵢ)/sgn(αᵢ)) [symbol] (θ)ᵢⱼ=t² for all j∈L (by Eq. (S91)). Fact (2): | [symbol] (θ)ᵢⱼ|≤ [symbol] (θ)ⱼⱼ for all i (by the fact that the Fisher information matrix is positive semidefinite). These facts imply that an optimal protocol must have [symbol] (θ)ⱼⱼ=t² for all j∈L. The fact that < [symbol] (t)>=0 for all j∈L and the fact that all sensors in L must be in a cat-like state over computational basis states follows immediately via an identical calculation to the proof of Lemma S1 for each j∈L. From Eq. (S24) it follows directly that these cat-like states over the qubit sensors in L must take the form in the theorem statement in order to achieve the correct sign on the components of [symbol] (θ). □

Using Lemma S5, restrict the set [symbol] of states such that [symbol] ⱼ⁽ⁿ⁾=sign(αⱼ)/sgn(α₁) for all j∈L and all τ⁽ⁿ⁾. This is the generalization of the fact that that, when |L|=1, we require [symbol] ₗ⁽ⁿ⁾=1 for all τ⁽ⁿ⁾.

In addition, given the required form of the optimal states, generalize Eq. (S25) to the condition that

$${\sum }_{i ∈ L} [ {λ}_{i} {\int }_{0}^{t} {ds}^{′} 〈 ψ ( {s}^{′} ) \vert {\hat{σ}}_{i}^{z} {\hat{σ}}_{j}^{z} \vert ψ ( {s}^{′} ) 〉 ] = \frac{{α}_{j}}{{α}_{1}} t , \qquad ( S94 )$$

which implies that, for protocols switching between states in the modified [symbol] ,

$${\sum }_{i ∈ L} [ {λ}_{i} {\sum }_{l = 0}^{n} ( {t}_{l + 1}^{*} - {t}_{l}^{*} ) {τ}_{j}^{( l )} ] = \frac{{α}_{j}}{{α}_{1}} t , \qquad ( S95 )$$

where one assumes that one switches to the state labeled by T^{(l)} at time τₗ^{*}. As before, in our protocols tₗ₊₁^{*}−tₗ^{*}=pₗt. In addition, Σᵢλᵢ=1. So an optimal protocol requires

$$t {\sum }_{l = 0}^{n} {p}_{l} {τ}_{j}^{( l )} = \frac{{α}_{j}}{{α}_{1}} t \text{=} Tp = α , \qquad ( S96 )$$

recovering Eq. (13) for general L, with the addition that Tᵢₙ [symbol] ⱼ⁽ⁿ⁾=sgn(αⱼ)/sgn(α₁) for all j∈L and all n.
Generalizing the proof of Theorem 1.

The proof was provided in two parts, wherein it was shown the existence of an optimal protocol using k-partite entangled cat-like states, subject to the upper bound of the theorem statement. The second part showed that, subject to the lower bound of the theorem statement, there exists no optimal protocol using only (k−1)-partite entanglement.

The first part changes upon relaxing the assumption that |α₁|>|αⱼ| for all j>1. Given that [symbol] ⱼ⁽ⁿ⁾=sgn(αⱼ)/sgn(α₁) for all j∈L and all τ⁽ⁿ⁾, the first |L| rows of T^{(k)} yield redundant equations in Eq. (19). Therefore, set \tilde{T}^{(k)} as T^{(k)} with all rows j∈L\{1} eliminated. Similarly, \tilde{α} is α with elements j∈L\{1} eliminated. Further, define the new system of equations, which are called System A\tilde{ }:

$${\tilde{T}}^{( k )} {\tilde{p}}^{( k )} = \tilde{α} / α 1 , \qquad ( S97 )$$

$${\tilde{p}}^{( k )} \geq 0. \qquad ( S98 )$$

System A has a solution if and only if System Ã does. Proceed as in the proof above to show via the Farkas-Minkowski lemma that System Ã has a solution if ∥α|₁/∥α∥∞≤k=⇒|α|₁/∥\tilde{α}|∞≤k−|L|+1. The details of the proof of this part are completely identical with this substitution.

The second part of the proof can similarly be adjusted straightforwardly. In particular, to satisfy the condition of Eq. (S91), which is the generalization of Eq. (8), for j∈L we require

$$\frac{{α}_{j}}{{α}_{1}} {t}^{2} = \frac{sgn ( {α}_{j} )}{sgn ( {α}_{1} )} {t}^{2} = {\sum }_{i ∈ L} \frac{sgn ( {α}_{1} )}{sgn ( {α}_{i} )} ℱ {( θ )}_{ij} {λ}_{i} , \qquad ( S99 )$$

which implies

$${t}^{2} = {\sum }_{i ∈ L} \frac{sgn ( {α}_{i} )}{sgn ( {α}_{j} )} ℱ {( θ )}_{ij} {λ}_{i} . \qquad ( S100 )$$

This in turn implies that for i,j∈L

$$ℱ {( θ )}_{ij} = \frac{sgn ( {α}_{i} )}{sgn ( {α}_{j} )} {t}^{2} . \qquad ( S101 )$$

Therefore, for all i∈L we require [symbol] (θ)ᵢᵢ=t². From here, arguments identical to those above apply to all i∈L, not just i=1. That is, all the probe states must always be fully entangled on the qubits in L and matrix elements [symbol] (θ)ᵢⱼ for i∈L, j∉L can only accumulate magnitude if sensor j is also entangled with the qubits in L. Assuming the existence of an optimal protocol using (k−1)-partite entanglement, a contradiction arises in an identical way.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix (s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

What is claimed is:

1. A process for measuring a single linear function q(θ1, θ2, . . . , θd) of unknown parameters {θ1, θ2, . . . , θd} with a quantum sensor network while using the minimum amount of entanglement, the process comprising:
providing a plurality of d quantum sensors, wherein each quantum sensor j is configured for measuring θj;
preparing the plurality of quantum sensors in a probe quantum state |Ψ> with a minimum amount of entanglement, such that the amount of entanglement is the smallest amount of entanglement that gives the same optimal measurement of the linear function q(θ1, θ2, . . . , θd) as if the amount of entanglement was not restricted;
exposing the plurality of quantum sensors to the set of unknown parameters;
measuring the plurality of quantum sensors; and
calculating the single linear function q(θ1, θ2, . . . , θd) from the measurements of the plurality of quantum sensors with robust phase estimation.

2. The process of claim 1, wherein calculating the single linear function q(θ1, θ2, . . . , θd) comprises embedding the single linear function q(θ1, θ2, . . . , θd) into relative phase of probe quantum state |Ψ>.

3. The process of claim 1, further comprising:
normalizing α, for α∈ [symbol] ^{d}, such that ∥α∥∞=1 (step 201);
determining a nonnegative solution p to Tp=α (step 202);
restricting p to its N̅ nonzero elements (step 203);
restricting T to its columns that correspond to N̅ nonzero elements of p (step

204. ;
initializing a quantum state on d qubits to |0>⊗^{d} (step 205);
preparing first state |ψ(τ⁽¹⁾; 0) [symbol] (step 206);
coherently switching to second state |ψ(τ⁽²⁾: ϕ₁) [symbol] from first state |(τ⁽¹⁾; 0) [symbol] (step 207);
repeatedly using CNOT and \hat{σ}^{x} gates for all states in T and remaining in a family parameterized by τ⁽ⁿ⁾ for time pₙt, forming final state |(ψ(τ^{(N̅)};qt) [symbol] (step 208); and
optionally converting, using CNOT and \hat{σ}^{x} gates, final state |ψ(τ^{N̅)}; qt) to 1/\sqrt{2}(|0>+e^{iqt}|1>)|0>⊗^{d-1} (step 209).

4. The process of claim 3, further comprising, after restricting p (step 203) and restricting T (step 204), reordering elements of p and columns of T (step 210), wherein N̅ σ corresponding to the columns of T are families of states used in the protocol.

5. The process of claim 3, wherein preparing first state |ψ(τ⁽¹⁾; 0) [symbol] occurs in response to using CNOT and \hat{σ}^{x} gates.

6. The process of claim 3, further comprising remaining in a family of first state |ψ(τ⁽¹⁾; 0) [symbol] for first time p₁t (step 211), wherein first time p₁t is an amount of time required by the current step of the robust phase estimation protocol.

7. The process of claim 6, further comprising preparing state |ψ(τ⁽¹⁾; ϕ₁) [symbol] from first state |ψ(τ⁽¹⁾; 0) [symbol] after first time p₁t, wherein ϕ₁=Σⱼp₁tτⱼ⁽¹⁾θⱼ (step 212).

8. The process of claim 3, wherein coherently switching to second state |ψ(τ⁽²⁾; ϕ₁) [symbol] occurs in response to using CNOT and \hat{σ}^{x} gates.

9. The process of claim 3, further comprising remaining in a family of second state |ψ(τ⁽²⁾; ϕ₁) [symbol] for second time p₂t (step 213).

10. The process of claim 9, further comprising preparing state |ψ(τ⁽²⁾; ϕ₁+ϕ₂) [symbol] from second state |ψ(τ⁽²⁾; ϕ₁) [symbol] after second time p₂t, wherein ϕ₂=Σⱼp₂tτⱼ⁽²⁾θⱼ (step 214).

11. The process of claim 3, wherein determining the nonnegative solution p (step 202) comprises making the determination from experimental desiderata oran optimization algorithm.

12. The process of claim 3, wherein final state |ψ(τ^{(N̅)}; qt) [symbol] is measured according to robust phase estimation that extracts the single linear function q(θ1, θ2, . . . , θd) with optimal scaling up to a constant factor.

13. The process of claim 3, further comprising, skipping step 209 and instead measuring the phase from final state |ψ(τ^{(N̅)}; qt) [symbol] using single-qubit measurements; and computing a parity in an absence of converting, using CNOT and \hat{σ}^{x} gates, final state |ψ(τ^{(N̅)}; gt) [symbol] to 1/\sqrt{2}(|0>+e^{iqt}|1>)|0>⊗^{d-1}.

14. The process of claim 1, wherein the plurality of quantum sensors is arranged in a network.

15. The process of claim 1, wherein the plurality of quantum sensors is qubits, interferometers, or field-quadrature displacement sensors.

16. The process of claim 1, wherein the set of unknown parameters is a set of field amplitudes, a set of temperatures, a set of pressures, a set of strains, a set of forces, a set of magnetic fields, a set of electric fields, or a set of gravitational fields.

17. A quantum sensor network comprising:
a plurality of quantum sensors, each quantum sensor j is configured for measuring θj out of a set of unknown parameters {θ1, θ2, . . . , θd}, such that the plurality of quantum sensors is configured to be in a probe quantum state |Ψ> with a minimum amount of entanglement, such that the amount of entanglement is the smallest amount of entanglement that gives the same optimal measurement of the linear function q(θ1, θ2, . . . , θd) as if the amount of entanglement was not restricted;
a network topology that connects the plurality of quantum sensors; and
a controller that is configured to:
prepare the plurality of quantum sensors in the probe quantum state expose the plurality of quantum sensors to the set of unknown parameters {θ1, θ2, . . . , θd};
measure the plurality of quantum sensors; and
use the measurements of the plurality of quantum sensors to calculate the function q(θ1, θ2, . . . , θd) of the set of unknown parameters.

18. The quantum sensor network of claim 17, wherein the plurality of quantum sensors is arranged in a linear array.

19. The quantum sensor network of claim 17, wherein the plurality of quantum sensors is arranged in a two-dimensional array.

20. The quantum sensor network of claim 17, wherein the plurality of quantum sensors is arranged in a three-dimensional array.

21. The quantum sensor network of claim 17, wherein the plurality of quantum sensors is qubits, interferometers, or field-quadrature displacement sensors.

22. The quantum sensor network of claim 17, wherein the set of unknown parameters is a set of field amplitudes, a set of temperatures, a set of pressures, a set of strains, a set of forces, a set of magnetic fields, a set of electric fields, or a set of gravitational fields.

23. A process for making a quantum sensor network that measures a single linear function q(θ1, θ2, . . . , θd), the process comprising:
providing a plurality of d quantum sensors;
arranging the plurality of quantum sensors j is configured for measuring ej out of a set of unknown parameters {θ1, θ2, . . . , θd};
connecting the plurality of quantum sensors to a controller;
preparing, by the controller, the plurality of quantum sensors in a probe quantum state |Ψ> with a minimum amount of entanglement, such that the amount of entanglement is the smallest amount of entanglement that gives the same optimal measurement of the linear function q(θ1, θ2, . . . , θd) as if the amount of entanglement was not restricted.

24. The process of claim 23, wherein the plurality of quantum sensors is arranged in a linear array.

25. The process of claim 23, wherein the plurality of quantum sensors is arranged in a two-dimensional array.

26. The process of claim 23, wherein the plurality of quantum sensors is arranged in a three-dimensional array.

27. The process of claim 23, wherein the plurality of quantum sensors is qubits, interferometers, or field-quadrature displacement sensors.

28. The process of claim 23, wherein the network topology is a star topology, a ring topology, or a mesh topology.

29. The process of claim 23, wherein the controller is a classical computer.
